(19) United States
(12) Patent Application Publication
(10) Pub. No.: US 2018/0042220 A1
(43) Pub. Date: Feb. 15, 2018

(54) METHOD FOR CRYOPRESERVING SHEET-SHAPED CELL CULTURE

(71) Applicants: TERUMO KABUSHIKI KAISHA, Tokyo (JP); Osaka University, Osaka (JP)

(72) Inventors: Shigeru MIYAGAWA, Osaka (JP); Yoshiki Sawa, Osaka (JP); Hirotatsu Ohkawara, Osaka (JP); Satsuki Fukushima, Osaka (JP); Atsuhiro Saito, Osaka (JP); Hiroko Iseoka, Ashigarakami-gun (JP)

(73) Assignees: TERUMO KABUSHIKI KAISHA, Tokyo (JP); OSAKA UNIVERSITY, Osaka (JP)

(21) Appl. No.: 15/784,460

(22) Filed: Oct. 16, 2017

Related U.S. Application Data
(63) Continuation of application No. PCT/JP2016/062061, filed on Apr. 15, 2016.

(30) Foreign Application Priority Data
Apr. 17, 2015 (JP) 2015-085447

(51) Int. Cl. A01N 1/02

(52) U.S. Cl. CPC A01N 1/0268; A01N 1/021

(57) ABSTRACT

Methods are disclosed of freezing, cryopreserving, and transferring a frozen sheet-shaped cell culture. The method of freezing includes (1) a step of immersing in a cryopreservation solution a sheet-shaped cell culture supported by a mesh-shaped support body; (2) a step of removing the cryopreservation solution adhered to the sheet-shaped cell culture, while keeping the sheet-shaped cell culture supported by the mesh-shaped support body; (3) a step of enclosing the sheet-shaped cell culture in a cold-resistant film, an upper surface and a lower surface of the sheet-shaped cell culture being covered by the mesh-shaped support body; and (4) a step of freezing the sheet-shaped cell culture.

### CROSS-REFERENCES TO RELATED APPLICATIONS

This application is a continuation of International Application No. PCT/JP2016/062061 filed on Apr. 15, 2016, which claims priority to Japanese Application No. 2015-085447 filed on Apr. 17, 2015, the entire contents of which are incorporated herein by reference.

### TECHNICAL FIELD

The present disclosure relates, inter alia, to a freezing method, a cryopreserving method, and a transferring method for a sheet-shaped cell culture.

### BACKGROUND DISCUSSION

In recent years, attempt to transplant various cells have been made in order to repair injured tissue or the like. For example, for repairing cardiac muscle tissue injured due to ischemic cardiopathy, such as stenocardia and cardiac infarction, dilated cardiomyopathy, etc., attempts have been made to utilize fetal cardiac myocytes, skeletal myoblasts, mesenchymal stem cells, cardiac stem cells, ES cells and the like (See Haraguchi et al., Stem Cells Transl Med. 2012 February; 1(2): 136-41 and Sawa et al., Surg Today. 2012 January; 42(2): 181-4).

As part of such attempts, cell structures formed by use of a scaffold and sheet-shaped cell cultures obtained by forming cells into a sheet shape have been developed (JP-T-2007-528755 and Sawa et al., Surg Today. 2012 January; 42(2): 181-4).

In regard of application of a sheet-shaped cell culture to therapy, investigations of utilization of a cultured skin sheet for skin injury due to burn or the like, utilization of a sheet-shaped cell culture of corneal epithelium for a corneal injury, utilization of a sheet-shaped cell culture of oral mucosa for endoscopic resection of esophageal cancer, etc. have been under way.

In the case of clinical application of a sheet-shaped cell culture, a cell-preparing chamber (CPC) with a high degree of sanitation can be required for the production of the sheet-shaped cell culture. Since a high maintenance cost may be needed for the maintenance of a cell-preparing chamber, inclusive of sanitary control and precision control of apparatuses, the production facility may be limited. In addition, a lot of human resources and care are required for the preparation of a sheet-shaped cell culture, from the preceding day to the day of transplantation. Thus, the burden required for the preparation for therapy is relatively large, which is one of the factors hampering the spread of the therapy by sheet-shaped cell cultures.

In order to solve such a problem, attempts have been made to enhance the usefulness of a sheet-shaped cell culture by cryopreservation thereof. For example, JP-A-2011-115058 describes a method of preserving a sheet-shaped cell culture comprising a step of freezing a sheet-shaped cell culture formed on a culture substrate with keeping it adhered to the culture substrate. Maehara et al., BMC Biotechnol. 2013 Jul. 25; 13: 58 states that a rabbit cartilage cell sheet supported by Cell Shifter (which is a paper-formed support body) was cryopreserved by a vitrification freezing method.

### SUMMARY

A method of cryopreserving a sheet-shaped cell culture is disclosed, wherein the method described in Maehara et al., BMC Biotechnol. 2013 Jul. 25; 13: 58 to a sheet-shaped cell culture composed of other cells than cartilage cells was found that the sheet-shaped cell culture would be broken and was difficult to cryopreserve the sheet-shaped cell culture. In accordance with an exemplary embodiment, it was found that when a mesh-shaped support body is used, a sheet-shaped cell culture composed of other cells than cartilage cells can be cryopreserved without being broken and while maintaining the quality thereof before freezing.

In accordance with exemplary embodiments, the present disclosure relates to the following:

<1> A method of freezing a sheet-shaped cell culture, comprising:

(1) a step of immersing in a cryopreservation solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body; and

(4) a step of freezing the sheet-shaped cell culture.

<2> A method of cryopreserving a sheet-shaped cell culture, comprising:

(1) a step of immersing in a cryopreserving solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body;

(4) a step of freezing the sheet-shaped cell culture; and

(5) a step of preserving the frozen sheet-shaped cell culture at a low temperature while keeping the sheet-shaped cell culture enclosed in the film.

<3> A method of transferring a sheet-shaped cell culture, comprising:

(1) a step of immersing in a cryopreservation solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body;

(4) a step of freezing the sheet-shaped cell culture; and

(5) a step of transferring the frozen sheet-shaped cell culture while keeping the sheet-shaped cell culture enclosed in the film.

<4> The method according to any one of the above paragraphs <1> to <3>, wherein in the step (1), the sheet-shaped cell culture is immersed in the cryopreservation solution for 1 to 30 minutes.

<5> The method according to any one of the above paragraphs <1> to <4>, wherein in the step (2), the cryopreservation solution adhered to the sheet-shaped cell culture is removed by dropping through the mesh-shaped support body.

<6> The method according to any one of the above paragraphs <1> to <5>, wherein in the step (3), the sheet-shaped cell culture is enclosed in the cold-resistant film in such a manner that a hermetically sealed state can be maintained.

<7> The method according to any one of the above paragraphs <1> to <6>, wherein in the step (4), the sheet-shaped cell culture is frozen by being placed on a liquid surface of liquid nitrogen.

<8> The method according to any one of the above paragraphs <1> to <7>, wherein the step (4) is conducted after the step (3).

Though not intending to be bound by a specific theory, in known methods, the support body is a paper-like form and the support body is in contact with the entire surface of a sheet-shaped cell culture. In the case of a fragile sheet-shaped cell culture, even a slight strain in the support body results in an excessive mechanical stimulus to the sheet-shaped cell culture, leading to breakage of the sheet-shaped cell culture. When a mesh-shaped support body is used, for example, the area of contact between the sheet-shaped cell culture and the support body is reduced, and an excessive mechanical stimulus on the sheet-shaped cell culture is avoided. In addition, when the sheet-shaped cell culture is taken out from a cryopreservation solution, the surplus cryopreservation solution drops through the mesh openings, so that removal of unrequired cryopreservation solution can be conducted more effectively. These are considered to constitute the reason why even a fragile sheet-shaped cell culture can be cryopreserved without breakage or deterioration of quality thereof.

In accordance with an exemplary embodiment, according to the present disclosure, even a fragile sheet-shaped cell culture can be cryopreserved and thawed, without damaging the shape or quality thereof. Therefore, the cumbersome preparatory work and human resources therefor, conventionally needed from several days before transplantation, can be made unnecessary. In addition, for example, in a hospital, which a CPC is unequipped, a sheet-shaped cell culture can be transferred in a frozen state from a production facility, and a sheet-shaped cell culture in a usable state can be easily prepared immediately before transplantation. Therefore, it may be expected to result in the remarkable increase in number of medical facilities where therapy by use of sheet-shaped cell cultures can be provided and drastic spread of the therapy. The simplification of preparatory work is especially useful in cases of emergency.

In addition, since long-term preservation of a sheet-shaped cell culture is enabled by the present disclosure, it is possible to preliminarily produce sheet-shaped cell cultures and stock them in a frozen state, for use in cases of emergency.

### BRIEF DESCRIPTION OF THE DRAWINGS

FIG. 1 is a photograph representing a manner in which a sheet-shaped cell culture supported by a mesh-shaped support body is immersed in a cell preservation solution.

FIG. 2 is a photograph representing a manner in which a sheet-shaped cell culture sandwiched between two sheets of mesh-shaped support bodies is enclosed in a film in a hermetically sealed state.

FIG. 3 is a photograph representing an external appearance, after thawing, of a sheet-shaped cell culture cryopreserved while kept supported by a paper-formed support body.

FIG. 4 is a photograph representing an HE stained image, after thawing, of a sheet-shaped cell culture cryopreserved while kept supported by a paper-formed support body.

FIG. 5 is a photograph representing a manner in which a sheet-shaped cell culture after thawing is transferred to a dish.

FIG. 6 is a photograph representing an external appearance, after thawing, of a sheet-shaped cell culture cryopreserved by use of a mesh-shaped support body.

FIG. 7 is a photograph representing an HE stained image, after thawing, of a sheet-shaped cell culture cryopreserved by use of a mesh-shaped support body.

FIG. 8 represents photographs of HE stained images (left) and electron microscope images (right), before freezing (top) and after thawing (bottom), of a sheet-shaped cell culture cryopreserved by use of a mesh-shaped support body. Arrowheads in the electron microscope images indicate positions of desmosome.

FIG. 9 represents photographs of immunostaining images of intercellular matrix components (left: fibronectin, center: collagen IV, and right: N-cadherin), before freezing (top) and after thawing (bottom), of a sheet-shaped cell culture cryopreserved by use of a mesh-shaped support body.

FIG. 10 represents a graph of cell survival rate of a sheet-shaped cell culture cryopreserved by use of a mesh-shaped support body (n=4), before freezing (0 hr) and upon thawing after cryopreservation for two days (2 d), seven days (7 d) or 28 days (28 d). The abbreviation “n.s.” represents no significant difference, or “not significant.”

FIG. 11 represents photographs of evaluation of apoptosis, before freezing (top) and after thawing (bottom), of a sheet-shaped cell culture cryopreserved by use of a mesh-shaped support body. The photographs represent immunostaining images of caspase 3, immunostaining images of caspase 8, immunostaining images of caspase 9, TUNEL stained images, and immunostaining images of ss-DNA, in this order from the left.

FIG. 12 represents graphs of gene expression of mitochondria-related protein in a sheet-shaped cell culture cryopreserved by use of a mesh-shaped support body (n=4), before freezing (0 hr) or upon thawing after cryopreservation for two days (2 d), seven days (7 d) or 28 days (28 d).

FIG. 13 represents graphs of gene expression of various cytokines in a sheet-shaped cell culture cryopreserved by use of a mesh-shaped support body (n=4), before freezing (0 hr) or upon thawing after cryopreservation for two days (2 d), seven days (7 d) or 28 days (28 d).

FIG. 14 represents photographs of evaluation by immunostaining of expression of various cytokines (left: VEGF, center: HIF-1α, and right: HGF), before freezing (top) and after thawing (bottom), in a sheet-shaped cell culture cryopreserved by use of a mesh-shaped support body.

FIG. 15 represents photographs of external appearance, before freezing (top) and after thawing (bottom), of a sheet-shaped cell culture cryopreserved by use of a mesh-shaped support body.

FIG. 16 represents photographs (the first ones from the left) of HE stained images and photographs of evaluation by immunostaining of expression of intercellular adhesion-related molecules (fibronectin, collagen III, and N-cadherin, in this order from the second ones from the left), before freezing (top) and after thawing (bottom), of a sheet-shaped cell culture cryopreserved by use of a mesh-shaped support body.

FIG. 17 is a graph of cell survival rate of a sheet-shaped cell culture cryopreserved by use of a mesh-shaped support body (n=10), before freezing (black) and upon thawing after cryopreservation (white).

FIG. 18 represents photographs of evaluation of apoptosis, before freezing (top) and after thawing (bottom), of a sheet-shaped cell culture cryopreserved by use of a mesh-shaped support body. The photographs represent immunostaining images of caspase 8, immunostaining images of caspase 9, immunostaining images of cytochrome-C, and immunostaining images of BCL-2, in this order from the left.

FIG. 19 represents photographs of evaluation of apoptosis, before freezing (top) and after thawing (bottom), of a sheet-shaped cell culture cryopreserved by use of a mesh-shaped support body. The left photographs represent TUNEL stained images, and the right ones represent immunostaining images of ss-DNA.

FIG. 20 represents graphs of gene expression of mitochondria-related protein in a sheet-shaped cell culture cryopreserved by use of a mesh-shaped support body (n=8), before freezing (black) and upon thawing after cryopreservation (white). The abbreviation “n.s.” represents no significant difference, or “not significant.”

FIG. 21 represents photographs of electron microscope images of mitochondria, before freezing (top) and after thawing (bottom), of a sheet-shaped cell culture cryopreserved by use of a mesh-shaped support body.

FIG. 22 represents graphs of gene expression of various cytokines in a sheet-shaped cell culture cryopreserved by use of a mesh-shaped support body (n=8), before freezing (black) and upon thawing after cryopreservation (white). The abbreviation “n.s.” represents no significant difference, or “not significant.”

FIG. 23 represents photographs of evaluation by immunostaining of expression of various cytokines (left: VEGF, center: HIF-1α, right: HGF), before freezing (top) and after thawing (bottom), of a sheet-shaped cell culture cryopreserved by use of a mesh-shaped support body.

FIG. 24 represents a graph of Ki67 positive cell rate in a sheet-shaped cell culture cryopreserved by use of a mesh-shaped support body (n=5), before freezing (black) and upon thawing after cryopreservation (white). The abbreviation “n.s.” represents no significant difference, or “not significant.”

FIG. 25 represents photographs of evaluation by immunostaining of expression of proliferative cells (Ki67 positive cells), before freezing (top) and after thawing (bottom), in a sheet-shaped cell culture cryopreserved by use of a mesh-shaped support body.

FIG. 26 represents photographs of electron microscope images (overall image, nucleus, intercellular adhesion, and sarcomere, in this order from the left), before freezing (top) and after thawing (bottom), of a sheet-shaped cell culture cryopreserved by use of a mesh-shaped support body. Arrowheads in the electron microscope images indicate positions of desmosome.

### DETAILED DESCRIPTION

Unless otherwise defined herein, all the technical terms and scientific terms used herein have the same meanings as ordinarily understood by persons skilled in the art. All the patents, patent applications and other publications and information referred to herein are incorporated herein by reference in their entireties.

In accordance with an exemplary embodiment, an aspect of the present disclosure relates to a method of producing a frozen sheet-shaped cell culture (hereinafter it may be referred to simply as “producing method”), comprising:

(1) a step of immersing in a cryopreservation solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body; and

(4) a step of freezing the sheet-shaped cell culture.

In the present disclosure, the “sheet-shaped cell culture” refers to a cell culture which cells are interconnected each other to form a sheet-shaped body. The cells may be interconnected directly (inclusive of the case of interconnection through cell elements such as adhesion molecules) and/or through an intervening substance. The intervening substance is not particularly limited so long as it is a substance capable of at least physically (mechanically) interconnecting the cells, and examples thereof include an extracellular matrix (also called intercellular matrix). The intervening substance is preferably one derived from cells, particularly one derived from the cells constituting the cell culture. The cells are interconnected at least physically (mechanically), and may be further interconnected functionally, for example, chemically or electrically. The sheet-shaped cell culture may be composed of one cell layer (monolayer), or may be composed of two or more cell layers (laminated (multilayer), for example, two layers, three layers, four layers, five layers, or six layers).

In accordance with an exemplary embodiment, the sheet-shaped cell culture preferably does not contain a scaffold (support). A scaffold may be used in this technical field by adhering cells onto its surface and/or to its inside for the purpose of maintaining the physical integrity of the sheet-shaped cell culture, and known examples of the scaffold include a membrane made of polyvinylidene difluoride (PVDF). The sheet-shaped cell culture in the present disclosure may be one that is able to maintain its physical integrity even in the absence of such a scaffold. In addition, preferably, the sheet-shaped cell culture is composed of a substance or substances derived from the cells constituting the cell culture and does not include other substances.

In accordance with an exemplary embodiment, the cells constituting the sheet-shaped cell culture are not particularly limited so long as they are ones capable of forming a sheet-shaped cell culture, and examples thereof include adherent cells (adhesive cells). Examples of the adherent cells include adherent somatic cells (for example, myocardial cells, fibroblasts, epithelial cells, endothelial cells, hepatic cells, pancreatic cells, renal cells, adrenal cells, periodontal ligament cells, gingival cells, periosteal cells, skin cells, synovial cells, cartilage cells, etc.) and stem cells (for example, myoblasts, cardiac stem cells and the like tissue stem cells, embryonic stem cells, induced pluripotent stem (iPS) cells and the like pluripotent stem cells, mesenchymal stem cells, etc.). The somatic cells may be those differentiated from stem cells, particularly iPS cells. Non limited examples of the cells constituting the sheet-shaped cell culture include myoblasts (for example, skeletal myoblasts), mesenchymal stem cells (for example, those derived from bone marrow, adipose tissue, peripheral blood, skin, hair root, muscular tissue, uterine mucosa, placenta, or umbilical cord blood), myocardial cells, fibroblasts, cardiac stem cells, embryonic stem cells, iPS cells, synovial cells, cartilage cells, epithelial cells (for example, mouth mucosa epithelial cells, retinal pigment epithelial cells, or nasal mucosa epithelial cells), endothelial cells (for example, vascular endothelial cells), hepatic cells (for example, hepatic parenchymal cells), pancreatic cells (for example, islet cells), renal cells, adrenal cells, periodontal ligament cells, gingival cells, periosteal cells, skin cells, etc.

Further non-limited examples of the cells constituting the sheet-shaped cell culture include cells differentiated from iPS cells (for example, myocardial cells differentiated from iPS cells).

The cells constituting the sheet-shaped cell culture can be derived from any organism that can be therapeutically treated by the sheet-shaped cell culture. Examples of such an organism include humans, nonhuman primates, dogs, cats, pigs, horses, goats, sheep, rodent animals (for example, mice, rats, hamsters, guinea pigs), and rabbits. In addition, the cells to be used for constituting the sheet-shaped cell culture may be only one kind of cells, or may be two or more kinds of cells. In a preferred embodiment of the present disclosure, in the case where the cells for forming the sheet-shaped cell culture are two or more kinds of cells, the proportion (purity) of the most abundant kind of cells, for example, is not less than approximately 60%, preferably not less than approximately 70%, and more preferably not less than approximately 75%, at the end of production of the sheet-shaped cell culture.

In accordance with an exemplary embodiment, the cells forming the sheet-shaped cell culture may be heterologous cells or may be homologous cells. Here, the term “heterologous cells” means cells derived from an organism of a species different from that of the recipient, in the case where the sheet-shaped cell culture is used for transplantation. For example, in the case where the recipient is a human, cells derived from a monkey or a pig correspond to the heterologous cells. In addition, the term “homologous cells” means cells derived from an organism of the same species as that of the recipient. For example, in the case where the recipient is a human, human cells correspond to the homologous cells. The homologous cells include self-derived cells (also called autologous cells), namely, cells derived from the recipient, and homologous non-autologous cells (also called allogeneic cells). The autologous cells are preferred in the present disclosure, since they do not cause rejection when transplanted. However, heterologous cells and homologous non-autologous cells can also be utilized. In the case where heterologous cells or homologous non-autologous cells are utilized, an immune restraining treatment may be needed, for restraining rejection. Note that herein other cells than autologous cells, namely, heterologous cells and homologous non-autologous cells may be generically referred to as allologous cells. In an exemplary embodiment of the present disclosure, the cells are autologous cells or allogeneic cells. In an exemplary embodiment of the present disclosure, the cells are autologous cells. In another exemplary embodiment of the present disclosure, the cells are allogeneic cells.

A sheet-shaped cell culture can be produced by any known method (see, for example, JP-T-2007-528755, JP-A-2010-081829, JP-A-2010-226991, JP-A-2011-110368, JP-A-2011-172925, and WO 2014/185517). In accordance with an exemplary embodiment, a method of producing a sheet-shaped cell culture can include a step of seeding cells on a culture substrate, a step of forming the seeded cells into a sheet, and a step of isolating the thus formed sheet-shaped cell culture from the culture substrate, but this is not restrictive. A step of freezing the cells and a step of thawing the cells may be performed before the step of seeding the cells on the culture substrate. Further, a step of washing the cells may be conducted after the step of thawing the cells. In addition, in the case where the sheet-shaped cell culture is a laminate sheet-shaped cell culture in which a plurality of sheet-shaped cell cultures are laminated, a step of laminating (multilayering) the plurality of sheet-shaped cell cultures may be included after the step of isolating the formed sheet-shaped cell culture from the culture substrate. Each of these steps can be carried out by any known method that is suited to the production of a sheet-shaped cell culture.

In the case where cells differentiated from iPS cells are used in the method of producing a sheet-shaped cell culture, the iPS cells can be derived into desired differentiated cells by any known method. For example, as a method for inducing myocardial cells from iPS cells, there have been known various methods (for example, Burridge et al., Cell Stem Cell. 2012 Jan. 6; 10(1): 16-28), and non-limited examples thereof include a method by embryoid body formation, a method by monolayer differentiation culture, and a method by forced aggregation. In each method, in accordance with an exemplary embodiment, derivation efficiency can be enhanced by sequentially bringing a mesoderm inducing factor (for example, activin A, BMP4, bFGF, VEGF, SCF, etc.), a cardiac specification factor (for example, VEGF, DKK1, Wnt signal inhibitor (for example, IWR-1, IWP-2, IWP-4, etc.), a BMP signal inhibitor (for example, NOGGIN, etc.), a TGFβ/activin/NODAL signal inhibitor (for example, SB431542, etc.), a retinoic acid signal inhibitor, etc.), and a cardiac differentiation factor (for example, VEGF, bFGF, DKK1, etc.) into action. In an exemplary embodiment, a treatment for inducing myocardial cells from iPS cells include sequentially making (1) BMP4, (2) a combination of BMP4 and bFGF and activin A, (3) IWR-1, and (4) a combination of VEGF and bFGF, act on an embryoid body formed under suspension culture.

As a cell population including the myocardial cells derived from iPS cells, a cell population after myocardial cell derivation that is obtained by subjecting iPS cells to a myocardial cell inducing treatment may be utilized as it is, a cell population enhanced in purity by purification of myocardial cells from a cell population after myocardial cell derivation may be utilized, a cell population lowered in purity by removing part of myocardial cells from a cell population after myocardial cell derivation may be utilized, and a mixture of a purified myocardial cell population with other cell population may be utilized.

The producing method of the present disclosure may further include a step of producing a sheet-shaped cell culture before the step (1). In that case, the step of producing the sheet-shaped cell culture may include one or more of the above-mentioned steps concerning the production of the sheet-shaped cell culture (namely, for example, the step of freezing cells, the step of thawing the cells, the step of washing the cells, the step of seeding cells on a culture substrate, the step of forming the seeded cells into a sheet, the step of isolating the formed sheet-shaped cell culture from the culture substrate, the step of laminating (multilayering) a plurality of sheet-shaped cell cultures, etc.). Therefore, an exemplary embodiment of the producing method of the present disclosure in which the sheet-shaped cell culture is a laminate sheet-shaped cell culture includes the step of laminating (multilayering) the plurality of sheet-shaped cell cultures before the step (1). In accordance with an exemplary embodiment, the producing method of the present disclosure may include a step of supporting the sheet-shaped cell culture isolated from the culture substrate (it may be referred to as isolated sheet-shaped cell culture) by a mesh-shaped support body, before the step (1).

In addition, the producing method of the present disclosure may further include a step of inducing iPS cells into differentiated cells and a step of enhancing purity by optionally purifying the myocardial cells, before the step of producing the sheet-shaped cell culture.

In accordance with an exemplary embodiment, the seeding of cells may be performed, for example, by pouring a cell suspension, obtained by suspending cells in a sheet-forming medium, into a culture vessel provided with a culture substrate. For pouring of the cell suspension, there can be used an implement suitable for a cell suspension pouring operation, such as a dropping pipette or a pipette. The seeding density of cells is not particularly limited so long as the seeded cells can form a sheet-shaped culture, and, for example, may be a density such that the cells can form a sheet-shaped cell culture without substantial growth. The “density such that the cells can form a sheet-shaped cell culture without substantial growth” means a cell density such that a sheet-shaped cell culture can be formed in the case where cells are cultured in a non-growth culture solution that substantially does not contain any growth factor. This seeding density is higher than that in a technique of using a culture solution containing a growth factor, and may be not less than a density such that the cells reach a confluent state. In accordance with an exemplary embodiment, a non-limited example of such a density, for example, is not less than approximately 1.0×105 cells/cm². An upper limit for the seeding density is not particularly limited unless formation of the cell culture is hampered or transition to differentiation of cells occurs, and the upper limit may be less than approximately 3.4×106 cells/cm².

The “density such that the cells can form a sheet-shaped cell culture without substantial growth”, for example, is approximately 1.0×105 to 3.4×106 cells/cm² in one embodiment, approximately 3.0×105 to 3.4×106 cells/cm² in another embodiment, approximately 3.5×105 to 3.4×106 cells/cm² in a further embodiment, approximately 1.0×106 to 3.4×106 cells/cm² in yet another embodiment, approximately 3.0×105 to 1.7×106 cells/cm² in a yet further embodiment, approximately 3.5×105 to 1.7×106 cells/cm² in still another embodiment, and approximately 1.0×106 to 1.7×106 cells/cm² in a still further embodiment. The above-mentioned ranges may include one or more of the upper limit and the lower limit, so long as the upper limit is less than approximately 3.4×106 cells/cm². Therefore, the density may be, for example, not less than approximately 3.0×105 cells/cm² to less than approximately 3.4×106 cells/cm² (inclusive of the lower limit and exclusive of the upper limit), not less than approximately 3.5×105 cells/cm² to less than approximately 3.4×106 cells/cm² (inclusive of the lower limit and exclusive of the upper limit), not less than approximately 1.0×106 cells/cm² to less than approximately 3.4×106 cells/cm² (inclusive of the lower limit and exclusive of the upper limit), more than approximately 1.0×106 cells/cm² to less than approximately 3.4×106 cells/cm² (exclusive of the lower limit and the upper limit), or more than approximately 1.0×106 cells/cm² to not more than approximately 1.7×106 cells/cm² (exclusive of the lower limit and inclusive of the upper limit).

Sheet formation of cells (sometimes called sheet-formation cultivation) can be performed by a method in which cells capable of forming a sheet-shaped cell culture are seeded in a culture vessel, and the cells are cultivated for a predetermined period under a condition for forming intercellular adhesion to cause the cells to interact with one another, thereby causing interconnection of the cells. The condition for forming the intercellular adhesion can include arbitrary conditions in which an intercellular adhesion can be formed, non-limited examples of which include ordinary cell cultivation conditions. Examples of such conditions include cultivation in an environment of 37° C. and 5% CO₂. In addition, one skilled in the art can select optimum conditions according to the kind of the cells to be seeded. Non-limited examples of sheet-formation cultivation are described in, for example, JP-T-2007-528755, JP-A-2010-081829, JP-A-2010-226991, JP-A-2011-110368, JP-A-2011-172925, and WO 2014/185517.

A medium to be used for sheet formation (sometimes called sheet-formation medium) is not particularly limited so long as the medium enables sheet formation of cells; for example, those based on physiological saline solution, various physiological buffers (for example, PBS or HBSS), or various basal media for cell cultivation may be used. Examples of such basal media include, without limitation, DMEM, MEM, F12, DME, RPMI1640, MCDB (MCDB102, 104, 107, 120, 131, 153, 199, etc.), L15, SkBM, RITC80-7, and DMEM/F12. Most of these basal media are commercially available, and their compositions are publicly known. A basal medium may be used as it has a standard composition (for example, as it is in the commercialized state), or may be used after appropriate modification of its composition according to the kind of cells or cell conditions. Therefore, the basal medium to be used in the present disclosure is not limited to those of known compositions, and include those in which one or more components have been added, removed, increased in quantity or decreased in quantity. The sheet-formation medium may include additives such as serum (for example, bovine serum such as fetal bovine serum, horse serum, or human serum) and various growth factors (for example, FGF, EGF, VEGF, or HGF).

The culture substrate is not particularly limited so long as it permits cells to form a sheet-shaped cell culture thereon, and examples of the culture substrate include containers made of various materials, and solid or semi-solid surfaces in containers. The container is preferably of such structure and material as to prevent liquids such as culture solution from permeating therethrough. Examples of such a material include, without limitation, polyethylene, polypropylene, Teflon (registered trademark), polyethylene terephthalate, polymethyl methacrylate, nylon 6,6, polyvinyl alcohol, cellulose, silicon, polystyrene, glass, polyacrylamide, polydimethylacrylamide, and metals (for example, iron, stainless steel, aluminum, copper, brass). In addition, the container preferably has at least one flat surface. Examples of such a container include, without limitation, cell culture dishes and cell culture bottles. In addition, the container may have a solid or semi-solid surface in the inside thereof. Examples of a solid surface include plates and containers of the above-mentioned various materials, and examples of a semi-solid surface include gels and flexible polymer matrixes. The culture substrate may be produced by use of the above-mentioned material, or a commercially available substrate may be utilized. Examples of a preferred culture substrate include, without limitation, substrates having an adhesive surface suitable for formation of a sheet-shaped cell culture. Specific examples of the preferred culture substrates include substrates having a hydrophilic surface, for example, substrates having a surface coated with a hydrophilic compound such as corona discharge-treated polystyrene, collagen gel or hydrophilic polymer, and, further, substrates having a surface coated with collagen, fibronectin, laminin, vitronectin, proteoglycan, glycosaminoglycan or the like extracellular matrix, or cadherin family, selectin family, integrin family or the like cell adhesion factor. In addition, such substrates are commercially available (for example, Corning® TC-Treated Culture Dish, made by Corning Inc.).

The culture substrate may have its surface coated with a material of which properties change in response to a stimulus, for example, temperature or light. Examples of materials which can be used as the just-mentioned material include, without limitation, temperature-responsive materials such as homopolymers or copolymers of (meth)acrylamide compounds, N-alkyl-substituted (meth)acrylamide derivatives (for example, N-ethylacrylamide, N-n-propylacrylamide, N-n-propylmethacrylamide, N-isopropylacrylamide, N-isopropylmethacrylamide, N-cyclopropylacrylamide, N-cyclopropylmethacrylamide, N-ethoxyethylacrylamide, N-ethoxyethylmethacrylamide, N-tetrahydrofurfurylacrylamide, N-tetrahydrofurfurylmethacrylamide, etc.), N,N-dialkyl-substituted (meth)acrylamide derivatives (for example, N,N-dimethyl(meth)acrylamide, N,N-ethylmethylacrylamide, N,N-diethylacrylamide), (meth)acrylamide derivatives having a cyclic group (for example, 1-(1-oxo-2-propenyl)-pyrrolidine, 1-(1-oxo-2-propenyl)-piperidine, 4-(1-oxo-2-propenyl)-morpholine, 1-(1-oxo-2-methyl-2-propenyl)-pyrrolidine, 1-(1-oxo-2-methyl-2-propenyl)-piperidine, 4-(1-oxo-2-methyl-2-propenyl)-morpholine, etc.), or vinyl ether derivatives (for example, methyl vinyl ether), light-absorptive high molecular compounds having an azobenzene group, and light-responsive materials such as copolymers of a vinyl derivative of triphenylmethane leucohydroxide with an acrylamide monomer, and N-isopropylacrylamide gel containing spirobenzopyran, etc. (see, for example, JP-A-1990-211865, JP-A-2003-33177). By giving a predetermined stimulus to these materials, the properties of the material, for example, hydrophilicity or hydrophobicity can be changed, whereby peeling of a cell culture adhering to the material can be promoted. Culture dishes coated with a temperature-responsive material are commercially available (for example, UpCell®, made by CellSeed Inc.), and they can be used in the producing method of the present disclosure.

The culture substrate may assume various shapes, but, preferably, the culture substrate is flat. In addition, the area of the culture substrate is not particularly limited, and can be, for example, approximately 1 to 200 cm², preferably approximately 2 to 100 cm², and more preferably approximately 3 to 50 cm².

The culture substrate may be coated with a serum. Where a serum-coated culture substrate is used, a sheet-shaped cell culture having a higher density can be formed. The language “coated with a serum” means that serum components are adhering to a surface of the culture substrate. Such a state can be obtained, for example, by treating the culture substrate with a serum, but this is not limitative. The treatment with a serum include contact of the serum with the culture substrate and, if necessary, incubation for a predetermined period. As the serum, heterologous serums and homologous serums can be used. The heterologous serum means a serum derived from an organism of a species different from that of the recipient, in the case where the cell culture is used for transplantation. For instance, where the recipient is a human, serums derived from cattle or horses, such as fetal bovine serum (FBS, FCS), calf serum (CS), and horse serum (HS) correspond to the heterologous serum. In addition, the “homologous serum” means a serum derived from an organism of the same species as that of the recipient. For instance, where the recipient is a human, human serums correspond to the homologous serum. The homologous serum includes the serum derived from the recipient, namely, autologous serum and homologous non-autologous serums derived from the same-species individuals other than the recipient. Note that herein other serums than autologous serum, namely, heterologous serums and homologous non-autologous serums may be generically referred to as allologous serums.

The serum with which to coat the culture substrate is commercialized, or can be prepared by a common method from a blood harvested from a desired organism. Specifically, for example, there may be mentioned a method in which a harvested blood is left to stand at room temperature, for example, for approximately 20 to 60 minutes to allow coagulation, the coagulated blood is centrifuged at approximately 1,000 to 1,200×g, and a supernatant is collected.

In the case of incubation on the culture substrate, the serum may be used in the state of raw liquid, or may be used in a diluted state. The dilution can be performed using an arbitrary medium, non-limited examples of which include water, physiological saline solution, various buffers (for example, PBS or HBS), and various liquid media (for example, DMEM, MEM, F12, DME, RPMI1640, MCDB (MCDB102, 104, 107, 120, 131, 153, 199, etc.), L15, SkBM, RITC80-7, DMEM/F12, etc.). The diluted concentration is not particularly limited so long as the serum components can be adhered onto the culture substrate, and is, for example, approximately 0.5% to 100% (v/v), preferably approximately 1% to 60% (v/v), and more preferably approximately 5% to 40% (v/v).

The incubation time also is not particularly limited so long as the serum components can be adhered onto the culture substrate, and is, for example, approximately 1 to 72 hours, preferably approximately 4 to 48 hours, more preferably approximately 5 to 24 hours, and further preferably approximately 6 to 12 hours. The incubation temperature also is not particularly limited so long as the serum components can be adhered onto the culture substrate, and is, for example, approximately 0° C. to 60° C., preferably approximately 4° C. to 45° C., and more preferably room temperature to approximately 40° C.

The isolation of the formed sheet-shaped cell culture from the culture substrate is not particularly limited so long as the sheet-shaped cell culture can be freed (peeled) from the culture substrate (serving as a scaffold) while at least partly keeping the sheet structure; for example, the isolation can be carried out by an enzyme treatment with a proteinase (for example, trypsin) and/or a mechanical treatment such as pipetting. In addition, in the case where the cell culture is formed by cultivating cells on a culture substrate having a surface coated with a material of which properties change in response to a stimulus such as temperature or light, the cell culture can be non-enzymatically freed by applying a predetermined stimulus.

In the case where the step of producing the sheet-shaped cell culture includes a step of freezing cells, this step can be carried out by any known technique for use in freezing cells. Examples of such a technique include, without limitation, serving the cells in a container to freezing means such as a freezer, a deep freezer, or a low-temperature medium (for example, liquid nitrogen). The temperature of the freezing means is not particularly limited so long as it is a temperature at which part, preferably the whole part, of a cell population in the container can be frozen, and, for example, is not higher than approximately 0° C., preferably not higher than approximately −20° C., more preferably not higher than approximately −40° C., and further preferably not higher than approximately −80° C. In addition, cooling rate in the freezing operation is not particularly limited so long as the survival rate and functions of cells after freezing and thawing are not largely damaged, and is a cooling rate (slow freezing) such that it takes, for example, approximately 1 to 5 hours, preferably approximately 2 to 4 hours, particularly approximately 3 hours, for the temperature to reach −80° C. after cooling is started from 4° C. Specifically, cooling can be conducted at a rate of approximately 0.46° C./minute, for example. Such a cooling rate can be achieved by a method wherein the container containing the cells is served to the freezing means set at a desired temperature, either directly or by containing it in a freezing treatment container. The freezing treatment container may have a function of controlling the lowering rate of temperature inside the container to a predetermined rate. As such a freezing treatment container, there can be used any known one, for example, BICELL® (Nihon Freezer Co., Ltd.).

The cell freezing operation may be conducted while keeping the cells immersed in a culture solution or a physiological buffer or the like, but may also be performed after such a treatment as adding to the culture solution a cryoprotective agent for protecting the cells from the freezing and thawing operations, or replacing the culture solution by a cryopreservation solution containing a cryoprotective agent. Therefore, the producing method of the present disclosure may further include a step of adding a cryoprotective agent to the culture solution, or a step of replacing the culture solution by a cryopreservation solution. In the case of replacing the culture solution by the cryopreservation solution, the cryopreservation solution may be added after removing the culture solution substantially completely or the cryopreservation solution may be added while the culture solution is partly remaining, if an effective concentration of the cryoprotective agent is contained in the liquid in which the cells are immersed at the time of freezing. Here, the “effective concentration” means a concentration at which the cryoprotective agent does not represent toxicity but represents a cryoprotective effect, for example, an effect to suppress lowering in survival rate, vitality, functions, and the like of cells after freezing and thawing, as compared to the case where the cryoprotective agent is not used. Such a concentration is known to persons skilled in the art, or can be appropriately determined by routine experiments or the like.

The cryoprotective agent to be used in freezing the cells is not particularly limited so long as it represents a cryoprotective action for the cells, and examples thereof include dimethyl sulfoxide (DMSO), glycerol, ethylene glycol, propylene glycol, sericin, propanediol, dextran, polyvinylpyrrolidone, polyvinyl alcohol, hydroxyethyl starch, chondroitin sulfate, polyethylene glycol, formamide, acetamide, adonitol, perseitol, raffinose, lactose, trehalose, sucrose, and mannitol. The cryoprotective agents may be used either singly or in combination of two or more of them.

The concentration of the cryoprotective agent in addition thereof to the culture solution, or the concentration of the cryoprotective agent in the cryopreservation solution is not particularly limited so long as the concentration is the above-defined effective concentration, and is typically, for example, approximately 2% to 20% (v/v) based on the whole part of the culture solution or the cryopreservation solution. However, concentrations that are outside the concentration range but are known for the respective cryoprotective agents or are substitutive use concentrations determined empirically can also be adopted, and such concentrations are included in the scope of the present disclosure.

In the case where the step of producing the sheet-shaped cell culture includes a step of thawing the frozen cells, this step can be carried out by any known cell thawing technique. In accordance with an exemplary embodiment, this step can be achieved, for example, by serving the frozen cells to thawing means, such as a solid, liquid or gaseous medium (for example, water), a water bath, an incubator, a thermostat or the like at a temperature higher than the freezing temperature, or by immersing the frozen cells in a medium (for example, culture solution) at a temperature higher than the freezing temperature, but this is not limitative. The temperature of the thawing means or the immersion medium is not particularly limited so long as it is a temperature at which the cells can be thawed in a desired time, and can be, for example, approximately 4° C. to 50° C., preferably approximately 30° C. to 40° C., and more preferably approximately 36° C. to 38° C. In addition, the thawing time is not particularly limited so long as the survival rate and functions of the cells after thawing are not largely damaged, for example, the thawing time can be within 2 minutes, and particularly within approximately 20 seconds, whereby a lowering in the survival rate can be largely suppressed. The thawing time can be controlled, for example, by changing the temperature of the freezing means or the immersion medium, or the volume or composition of the culture solution or the cryopreservation solution at the time of freezing.

The step of producing the sheet-shaped cell culture may include a step of washing the cells, after the step of thawing the frozen cells and before the step of forming the sheet-shaped cell culture. The washing of the cells can be performed by any known technique, and can be achieved, for example, by suspending the cells in a liquid (for example, a culture solution or physiological buffer containing or not containing serum or a serum component (serum albumin)), followed by centrifugation, discarding the supernatant and recovering the precipitated cells, but this is nonrestrictive. In the step of washing the cells, such a cycle of suspension, centrifugation and recovery may be performed one time or plural times (for example, 2, 3, 4, or 5 times). In addition, the step of washing the cells may be conducted immediately after the step of thawing the frozen cells.

In the case where the step of producing the sheet-shaped cell culture includes a step of laminating (multilayering) a plurality of sheet-shaped cell cultures, this step can be carried out, for example, by laying two or more sheet-shaped cell cultures on one another, either directly or through an intervening substance therebetween, to form a single sheet of sheet-shaped cell culture. Examples of the intervening substance include, without limitation, substances that accelerate and/or strengthen adhesion between the sheet-shaped cell cultures, and non-limited examples thereof include extracellular matrix components or compositions containing the same (for example, collagen, fibronectin, laminin, vitronectin, proteoglycan, glycosaminoglycan, hydrogel, or gelatin), adhesive proteins (for example, cadherin family, selectin family, or integrin family).

The sheet-shaped cell culture may be fragile. The strength of a sheet-shaped cell culture can be measured, for example, by a method of JP-A-2012-159408 or JP-A-2014-149214. Non limited examples of such a measuring method include a method wherein the sheet-shaped cell culture extended in a liquid is scooped up with an intestinal spatula made of stainless steel (for example, one of 45 mm in width) and is placed out of the liquid while keeping the sheet-shaped cell culture adhered to a surface of the intestinal spatula, a suture equipped with a needle (for example, 6-0 proline) is inserted between the sheet-shaped cell culture and the intestinal spatula, and passed through the sheet-shaped cell culture from a lower side to an upper side, then both ends of the thread are tied together to form a ring, which is connected to a gauge (for example, a general-purpose digital force gage, FGC-1B, manufactured by Nidec-Shimpo Corporation), the thread locked to the sheet-shaped cell culture is horizontally pulled through the gauge, and the maximum load before the sheet-shaped cell culture breaks (tensile breaking load) is measured. In a specific embodiment, the fragile sheet-shaped cell culture may have a strength in terms of a tensile breaking load of, for example, without limitation, approximately 0.001 to 0.05 N, approximately 0.002 to 0.04 N, approximately 0.003 to 0.03 N, approximately 0.004 to 0.02 N, or approximately 0.005 to 0.01 N. Non-limited examples of the fragile sheet-shaped cell culture include a sheet-shaped cell culture composed of skeletal myoblasts.

In the present disclosure, the mesh-shaped support body can include any support body of a mesh structure that is capable of supporting the sheet-shaped cell culture without spoiling the shape of the sheet-shaped cell culture and capable of removing a liquid such as a cryopreservation solution adhered to the sheet-shaped cell culture. The mesh-shaped support body is preferably one having a smooth surface such that the surface does not damage the sheet-shaped cell culture when supporting the sheet-shaped cell culture. The material of the support body is not particularly restricted so long as it satisfies the above-mentioned conditions, and examples thereof include plastics such as polypropylene and polyesters. The aperture ratio of the support body is not particularly limited so long as it satisfies the above-mentioned conditions, and the three-dimensional aperture ratio of the support body may be, for example, approximately 50% to 96%, approximately 60% to 95%, approximately 70% to 94%, approximately 75% to 93%, or approximately 80% to 92%. The filament diameter of the mesh is not particularly limited so long as it satisfies the above-mentioned conditions, and may be, for example, approximately 10 to 1,000 μm, approximately 20 to 500 μm, approximately 30 to 400 μm, approximately 40 to 300 μm, or approximately 50 to 250 μm. The mesh-shaped support body may have any of various structures such as knitted structures, woven structures, and non-woven structures. In addition, the mesh-shaped support body may have undergone a coating with affinity for living bodies (for example, titanium coating). The material (inclusive of the coating) constituting the mesh-shaped support body is preferably one that is not eluted in the cryopreservation solution. Non-limited examples of the mesh-shaped support body include surgical meshes such as TiLENE MESH (made by pfm medical ag.) and Parietex Mesh (made by Covidien plc).

In the present disclosure, the cryopreservation solution includes any liquids that are used for cryopreservation of cells. In a preferred embodiment, the cryopreservation solution is one that can be used for vitrification freezing. Cryopreservation solutions that can be used for vitrification freezing are known in the present technical field (see, for example, Maehara et al., BMC Biotechnol. 2013 Jul. 25; 13: 58). In accordance with an exemplary embodiment, the cryopreservation solution contains a cryoprotective agent for protecting cells from influences of freezing. Examples of the cryoprotective agent include, without limitation, cell-penetrating cryoprotective agents and non-cell-penetrating cryoprotective agents. Non-limited examples of the cryoprotective agent include, without limitation, dimethyl sulfoxide (DMSO), ethylene glycol, carboxylated polylysine, glycerol, propylene glycol, sericin, propanediol, dextran, polyvinylpyrrolidone, polyvinyl alcohol, hydroxyethyl starch, chondroitin sulfate, polyethylene glycol, formamide, acetamide, adonitol, perseitol, raffinose, lactose, trehalose, sucrose, and mannitol. The cryoprotective agents may be used either singly or in combination of two or more of them. In some embodiments, the cryopreservation solution contains both a cell-penetrating cryoprotective agent and a non-cell-penetrating cryoprotective agent.

The cryopreservation solution may contain a basal solution for dissolving and/or diluting the cryoprotective agent and maintaining survival of cells. The basal solution is not particularly restricted so long as it has the above-mentioned functions, and those based on physiological saline solution, various physiological buffers (for example, PBS or HBSS), or various basal media for cell cultivation may be used. Non-limited examples of the basal media include DMEM, MEM, F12, DME, RPMI1640, MCDB (MCDB102, 104, 107, 120, 131, 153, 199, etc.), L15, SkBM, RITC80-7, DMEM/F12, and TCM-199. Most of these basal media are commercialized, and their compositions are publicly known. The basal medium may be used as it has a standard composition (for example, as it is in the commercialized state), or may be used after appropriate modification of its composition according to the kind of cells or cell conditions. The basal medium to be used in the present disclosure is not limited to those of known compositions, and include those in which one or more components have been added, removed, increased in quantity or decreased in quantity. The basal solution may contain additives such as serum (for example, bovine serum such as fetal bovine serum, horse serum, or human serum) and various buffers (for example, Good buffer such as Hepes).

The concentration of the cryoprotective agent in addition thereof to the cryopreservation solution or the concentration of the cryoprotective agent in the cryopreservation solution is not particularly limited so long as it is a concentration at which the quality of the sheet-shaped cell culture is not excessively deteriorated by freezing and thawing operations. In accordance with an exemplary embodiment, the concentration can be, for example, approximately 1% to 30% (v/v), approximately 2% to 25% (v/v), or approximately 5% to 20% (v/v) for one kind of cryoprotective agent, based on the whole part of the cryopreservation solution. However, concentrations that are outside the concentration range but are known for the respective cryoprotective agents or are substitutive use concentrations determined empirically can also be adopted, and such concentrations are included in the scope of the present disclosure.

In accordance with an exemplary embodiment, the immersion in the cryopreservation solution in the step (1) is carried out by immersing the whole part of the sheet-shaped cell culture in the cryopreservation solution while keeping the sheet-shaped cell culture supported by the mesh-shaped support body. The immersion time is not particularly limited so long as the cryoprotective agent can act on the sheet-shaped cell culture, and may be, for example, approximately 1 to 30 minutes, approximately 2 to 20 minutes, or approximately 3 to 15 minutes, and may particularly be approximately 5 minutes. Only one kind of cryopreservation solution may be used, or a plurality of kinds of cryopreservation solutions may be used. From the viewpoint of minimizing bad influences on the sheet-shaped cell culture, it is preferable to immerse the sheet-shaped cell culture in only one kind of cryopreservation solution only once.

The removal of the cryopreservation solution in the step (2) is carried out, for example, by a method in which the cryopreservation solution adhered to the sheet-shaped cell culture is dropped through the mesh-shaped support body; however, the cryopreservation solution may be absorbed in a liquid-absorptive material through the mesh-shaped support body.

Before enclosure in a cold-resistant film, an upper surface and a lower surface of the sheet-shaped cell culture are covered by the mesh-shaped support body. The covering of the sheet-shaped cell culture may be performed by disposing two or more sheets of mesh-shaped support bodies on the upper surface and the lower surface of the sheet-shaped cell culture, or may be performed by folding one sheet of mesh-shaped support body in two, with the sheet-shaped cell culture interposed therebetween. With the upper surface and the lower surface of the sheet-shaped cell culture covered by the mesh-shaped support body or bodies, it is possible to prevent a situation in which the sheet-shaped cell culture adheres to the film at the time of freezing and is damaged when taken out from the film after thawing. Before enclosure in the cold-resistant film, the covering of the sheet-shaped cell culture by the mesh-shaped support body or bodies may be performed at any timing within the period from a timing before the step (1) to a timing between the step (2) and the step (3). More specifically, the covering can be performed before the step (1), during the step (1), between the step (1) and the step (2), during the step (2), or between the step (2) and the step (3). In accordance with an exemplary embodiment, in the case where the covering is conducted between the step (2) and the step (3), a process may be adopted wherein, for example, the sheet-shaped cell culture with its lower surface supported by the mesh-shaped support body is placed on the cold-resistant film, and the upper surface of the sheet-shaped cell culture is covered by a part of the same mesh-shaped support body or by another mesh-shaped support body.

The cold-resistant film is not particularly restricted so long as it can endure freezing and thawing operations, and examples thereof include films formed from plastics such as polyvinylidene chloride, polyvinyl chloride, polypropylene, polyethylene and nylon. In addition, the cold-resistant film is preferably one that permits hermetical sealing by fusing or the like. The cold-resistant film may be formed of one or more kinds of materials. The cold-resistant film may be sheet-like in shape, or may have been processed into a bag-like shape.

In accordance with an exemplary embodiment, the enclosure by the cold-resistant film in the step (3) is carried out by a method in which the whole part of the sheet-shaped cell culture is enclosed in the cold-resistant film, together with the mesh-shaped support body or bodies covering the sheet-shaped cell culture. The enclosure is preferably performed in such a manner that a hermetically sealed state can be maintained. For instance, in the case of a film formed from a thermoplastic material, the periphery is heat fused, whereby the inside can be hermetically sealed.

The freezing of the sheet-shaped cell culture in the step (4) can be performed by any known freezing technique which can be utilized for freezing of cells. In a preferred embodiment, the freezing is conducted by rapid freezing. The rapid freezing is a technique used for vitrification of a fertilized egg or the like, and is well known in the present technical field. The rapid freezing may be conducted by exposing the sheet-shaped cell culture to a medium, for example, nitrogen gas, at a low temperature of, for example, approximately −180° C. to −80° C., approximately −170° C. to −100° C., approximately −165° C. to −120° C., approximately −160° C. to −135° C., or approximately −150° C. to −140° C., which is non-limited. In addition, the cooling rate of the sheet-shaped cell culture in the rapid freezing is not particularly limited so long as vitrification of the sheet-shaped cell culture can be achieved without excessive deterioration of the quality of the sheet-shaped cell culture. In a specified embodiment, the rapid freezing is conducted by disposing the sheet-shaped cell culture over a liquid surface of liquid nitrogen. The position at which the sheet-shaped cell culture is disposed may be, for example, a position of approximately 0.5 to 2 cm, particularly approximately 1 cm, above the liquid surface of liquid nitrogen. The time of exposure to the low-temperature medium is not particularly limited so long as vitrification of the sheet-shaped cell culture can be accomplished, and may, for example, be approximately 1 to 40 minutes, approximately 2 to 30 minutes, approximately 3 to 25 minutes, or approximately 5 to 20 minutes.

The step (4) may be performed before or after the step (3). In an embodiment wherein the step (4) is conducted before the step (3), the matter to be enclosed in the cold-resistant film is the frozen sheet-shaped cell culture with its upper surface and lower surface covered by the mesh-shaped support body or bodies. In this embodiment, though not limited, there may be adopted, for example, a method wherein the sheet-shaped cell culture is frozen in the state of being supported by the mesh-shaped support body, then the upper surface and lower surface of the sheet-shaped cell culture are covered by the mesh-shaped support body or bodies, and the sheet-shaped cell culture is enclosed in the cold-resistant film together with the mesh-shaped support body or bodies, or a method wherein the sheet-shaped cell culture is frozen in the state of having its upper surface and lower surface covered by the mesh-shaped support body or bodies, and thereafter the sheet-shaped cell culture is enclosed in the cold-resistant film together with the mesh-shaped support body or bodies. In accordance with an exemplary embodiment, in an embodiment wherein the step (4) is conducted after the step (3), the matter to be enclosed in the cold-resistant film is the unfrozen sheet-shaped cell culture with its upper surface and lower surface covered by the mesh-shaped support body or bodies. In this embodiment, though not limited, there may be adopted a method wherein, for example, the unfrozen sheet-shaped cell culture having its upper surface and lower surface covered by the mesh-shaped support body or bodies and being enclosed in the cold-resistant film together with the mesh-shaped support body or bodies is frozen together with the cold-resistant film.

In accordance with another aspect of the present disclosure, a method is disclosed of freezing a sheet-shaped cell culture (hereinafter the method may be referred to simply as “the freezing method”), comprising:

(1) a step of immersing in a cryopreservation solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body; and

(4) a step of freezing the sheet-shaped cell culture.

The steps (1) to (4) in the freezing method of the present disclosure are as described above with reference to the producing method of the present disclosure. By the freezing method of the present disclosure, even a fragile sheet-shaped cell culture can be cryopreserved for a long time without deterioration of quality thereof.

In accordance with another aspect of the present disclosure, a method is disclosed of cryopreserving a sheet-shaped cell culture (hereinafter the method may be referred to simply as “the cryopreserving method”), comprising:

(1) a step of immersing in a cryopreserving solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body;

(4) a step of freezing the sheet-shaped cell culture; and

(5) a step of preserving the frozen sheet-shaped cell culture at a low temperature while keeping the sheet-shaped cell culture enclosed in the film.

The steps (1) to (4) of the cryopreserving method of the present disclosure are as described above with reference to the producing method of the present disclosure. The preservation at a low temperature in the step (5) is not particularly restricted so long as it does not cause excessive deterioration of the quality of the sheet-shaped cell culture, and may be conducted at a temperature of, for example, not higher than approximately −90° C., not higher than approximately −120° C., not higher than approximately −135° C., not higher than approximately −150° C., not higher than approximately −160° C., not higher than approximately −170° C., not higher than approximately −180° C., or not higher than approximately −190° C. In the case where the sheet-shaped cell culture is subjected to vitrification freezing, the preservation at a low temperature is preferably performed at a temperature at which a vitrified state can be maintained. In an exemplary embodiment, the preservation at a low temperature is performed in liquid nitrogen. The preservation period is not particularly limited, and may, for example, be not less than approximately one week, not less than approximately one month, not less than approximately two months, not less than approximately three months, not less than approximately six months, or not less than approximately one year.

In accordance with another aspect of the present disclosure, a method is disclosed of transferring a sheet-shaped cell culture (hereinafter the method may be referred to simply as “the transferring method”), comprising:

(1) a step of immersing in a cryopreservation solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body;

(4) a step of freezing the sheet-shaped cell culture; and

(5) a step of transferring the frozen sheet-shaped cell culture while keeping the sheet-shaped cell culture enclosed in the film.

The steps (1) to (4) in the transferring method of the present disclosure are as described above with reference to the producing method of the present disclosure. The transfer in the step (5) can be carried out by any technique that does not cause excessive deterioration of the quality of the sheet-shaped cell culture. In an embodiment, the transfer is conducted while keeping the sheet-shaped cell culture at a low temperature and in a frozen state. With the frozen state maintained, it is possible to prevent a situation in which the sheet-shaped cell culture moves inside the film and is exposed to a mechanical stimulus due to contact with the mesh-shaped support body or the like, and it is possible to reduce metabolism of the cells and to prevent deterioration of the quality. For the maintaining of the sheet-shaped cell culture at a low temperature, any movable low-temperature preservation device can be used. Such a low-temperature preservation device is not restricted, and examples thereof include a container filled with liquid nitrogen, and a portable deep freezer.

The freezing method, the cryopreserving method and the transferring method of the present disclosure may, like the producing method of the present disclosure, further include a step of producing a sheet-shaped cell culture before the step (1); in that case, the step of producing the sheet-shaped cell culture may include one or more of the above-mentioned steps concerning the production of the sheet-shaped cell culture (namely, the step of freezing cells, the step of thawing the cells, the step of washing the cells, the step of seeding the cells on a culture substrate, the step of forming the seeded cells into a sheet shape, the step of isolating the formed sheet-shaped cell culture from the culture substrate, the step of laminating (multi-layering) a plurality of sheet-shaped cell cultures, etc.). Therefore, an embodiment of the above-mentioned method of the present disclosure wherein the sheet-shaped cell culture is a laminate sheet-shaped cell culture includes a step of laminating (multi-layering) a plurality of sheet-shaped cell cultures before the step (1). In addition, the method may include a step of supporting the sheet-shaped cell culture isolated from the culture substrate (sometimes called the isolated sheet-shaped cell culture) by the mesh-shaped support body or bodies, before the step (1).

Another aspect of the present disclosure relates to a frozen sheet-shaped cell culture produced by the producing method of the present disclosure. The frozen sheet-shaped cell culture of the present disclosure maintains quality comparable to that before freezing, even after thawing, and can, after thawing, be utilized easily for transplantation or the like treatment without needing a cumbersome preparatory operation. The frozen sheet-shaped cell culture of the present disclosure has one or more of the following characteristics: (1) a sheet shape is maintained even after thawing; (2) intercellular adhesion is maintained even after thawing; (3) desmosome is maintained even after thawing; (4) an intercellular matrix is maintained even after thawing; (5) cell survival rate is maintained even after thawing; (6) apoptosis is not detected or is at a low level if detected, even after thawing; (7) functions of mitochondria are maintained even after thawing; (8) expression of cytokines is maintained even after thawing; (9) cell proliferation activity is maintained even after thawing; and (10) a microstructure of cells is maintained even after thawing. Here, though not limited, the expression “is (are) maintained” means that there is observed no substantial difference between a characteristic of the frozen sheet-shaped cell culture and that of an unfrozen sheet-shaped cell culture in the case where the characteristic is a qualitative characteristic; in the case of a quantitative characteristic, it means that there is observed no statistically significant difference between a characteristic of the frozen sheet-shaped cell culture and that of the unfrozen sheet-shaped cell culture or the difference from a numerical value for the unfrozen sheet-shaped cell culture is, for example, less than approximately 25%, preferably less than approximately 20%, more preferably less than approximately 15%, and particularly preferably less than approximately 10%.

The frozen sheet-shaped cell culture of the present disclosure may be provided in a state in which its upper surface and lower surface are covered by the mesh-shaped support body or bodies, or may further be provided in a state in which it is enclosed in the cold-resistant film together with the mesh-shaped support body or bodies. In the case where the frozen sheet-shaped cell culture is provided in the state in which its upper surface and lower surface are covered by the mesh-shaped support body or bodies, it is possible, after thawing the frozen sheet-shaped cell culture as it is, to remove the cryoprotective agent while keeping the sheet-shaped cell culture supported by the support body, and to use it for transplantation or the like treatment. In addition, in the case where the frozen sheet-shaped cell culture is provided in the state of being enclosed in the cold-resistant film, it is possible, after thawing the frozen sheet-shaped cell culture as it is, to take out the sheet-shaped cell culture together with the mesh-shaped support body, to remove the cryoprotective agent, if necessary, while keeping the sheet-shaped cell culture supported by the support body, and to use it for transplantation or the like treatment.

The thawing of the frozen sheet-shaped cell culture can be performed by any known method used for thawing of frozen cells. In accordance with an exemplary embodiment, the thawing is achieved, for example, by serving the frozen sheet-shaped cell culture to thawing means, such as a solid, liquid or gaseous medium (for example, water), a water bath, an incubator, a thermostat, a hot plate or the like at a temperature higher than the freezing temperature, or by immersing the frozen sheet-shaped cell culture in a medium (for example, culture solution) at a temperature higher than the freezing temperature, but this is nonrestrictive. The temperature of the thawing means or the immersion medium is not particularly limited so long as it is a temperature at which the frozen sheet-shaped cell culture can be thawed in a desired time, and can be, for example, approximately 4° C. to 50° C., preferably approximately 30° C. to 40° C., and more preferably approximately 36° C. to 38° C. In addition, the thawing time is not particularly limited so long as it does not excessively damage the quality of the frozen sheet-shaped cell culture after thawing, and can be, for example, within approximately 180 seconds, within approximately 150 seconds, within approximately 120 seconds, within approximately 90 seconds, within approximately 70 seconds, within approximately 60 seconds, within approximately 50 seconds, within approximately 40 seconds, within approximately 30 seconds, or within approximately 20 seconds. In accordance with an exemplary embodiment, adoption of a shorter thawing time can help prevent deterioration of quality. In accordance with an exemplary embodiment, the thawing time can be controlled, for example, by changing the temperature of the thawing means or the immersion medium, or the volume or composition of the culture solution or the cryopreservation solution at the time of freezing, or the like.

The removal of the cryoprotective agent can be performed, for example, without limitation, by bringing the sheet-shaped cell culture into contact with a washing liquid to transfer the cryoprotective agent into the washing liquid. The washing liquid is not particularly restricted so long as it does not contain the cryoprotective agent or contains the cryoprotective agent in a concentration lower than that in the cryopreservation solution and it does not excessively damage the quality of the sheet-shaped cell culture. Examples of the washing liquid include those based on physiological saline solution, various physiological buffers (for example, PBS or HBSS), or various basal media for cell cultivation. The washing liquid may contain additives such as serum, serum components (serum albumin, etc.), and sucrose. The washing liquid is preferably substantially isotonic with the cells, and is more preferably isotonic with the cells. The contact of the sheet-shaped cell culture with the washing liquid can be performed, for example, without limitation, by immersing the sheet-shaped cell culture in the washing liquid contained in a washing container suitable for putting in and out the sheet-shaped cell culture, such as a dish or a plate for cell cultivation. The immersion of the sheet-shaped cell culture may be conducted while keeping the sheet-shaped cell culture supported by the mesh-shaped support body. In addition, thawing and the removal of the cryoprotective agent may be conducted simultaneously, by immersing the sheet-shaped cell culture in the frozen state in the washing liquid set at an appropriate temperature. The contact with the washing liquid may be conducted only once, or further contact with one or more washing liquids which may be the same as or different from the original washing liquid in composition may be performed. The removal of the cryoprotective agent can be performed as required, for example, in the case where the cryoprotective agent would exert a bad influence on the quality of the sheet-shaped cell culture or on the treatment with the sheet-shaped cell culture.

Another aspect of the present disclosure relates to a thawed sheet-shaped cell culture obtained by thawing the frozen sheet-shaped cell culture of the present disclosure. The thawed sheet-shaped cell culture of the present disclosure may be one obtained by thawing the frozen sheet-shaped cell culture of the present disclosure, followed if necessary by removal of the cryoprotective agent. The thawed sheet-shaped cell culture of the present disclosure has one or more of the following characteristics: (1) a sheet shape before freezing is maintained; (2) intercellular adhesion before freezing is maintained; (3) desmosome before freezing is maintained; (4) an intercellular matrix before freezing is maintained; (5) cell survival rate before freezing is maintained; (6) apoptosis is not detected or is detected at an extremely low level; (7) functions of mitochondria before freezing are maintained; (8) expression of cytokines before freezing is maintained; (9) cell proliferation activity before freezing is maintained; and (10) a microstructure of cells before freezing is maintained. Here, though not limited, the expression “is (are) maintained” means that there is observed no substantial difference between a characteristic of the thawed sheet-shaped cell culture and that of an unfrozen sheet-shaped cell culture in the case where the characteristic is a qualitative characteristic; in the case of a quantitative characteristic, it means that there is observed no statistically significant difference between a characteristic of the thawed sheet-shaped cell culture and that of the unfrozen sheet-shaped cell culture or the difference from a numerical value for the unfrozen sheet-shaped cell culture is, for example, less than approximately 25%, preferably less than approximately 20%, more preferably less than approximately 15%, and particularly preferably less than approximately 10%.

In accordance with another aspect of the present disclosure, a method is disclosed of producing a thawed sheet-shaped cell culture, comprising:

(1) a step of immersing in a cryopreservation solution a sheet-shaped cell culture supported by a mesh-shaped support body;

(2) a step of removing the cryopreservation solution adhered to the sheet-shaped cell culture, while keeping the sheet-shaped cell culture supported by the mesh-shaped support body;

(3) a step of enclosing the sheet-shaped cell culture in a cold-resistant film, an upper surface and a lower surface of the sheet-shaped cell culture being covered by the mesh-shaped support body;

(4) a step of freezing the sheet-shaped cell culture; and

(5) a step of thawing the frozen sheet-shaped cell culture.

The steps (1) to (4) in the method of producing the thawed sheet-shaped cell culture of the present disclosure are as described above with reference to the method of producing the frozen sheet-shaped cell culture of the present disclosure. The thawing of the frozen sheet-shaped cell culture in the step (5) is as described above with reference to the thawing of the frozen sheet-shaped cell culture. The method of producing the thawed sheet-shaped cell culture of the present disclosure may further include a step of removing a cryoprotective agent.

The removal of the cryoprotective agent can be carried out as described above with reference to the frozen sheet-shaped cell culture. Therefore, the removal of the cryoprotective agent can be performed after the step (5), or can be performed simultaneously with the step (5).

The frozen sheet-shaped cell culture of the present disclosure can be utilized for treatment of various diseases associated with tissue abnormality, after thawing and, if necessary, removing the cryoprotective agent. In addition, the thawed sheet-shaped cell culture of the present disclosure can be used for treatment of various diseases associated with tissue abnormality, as it is or after removing the cryoprotective agent if necessary. Therefore, in an embodiment, the frozen sheet-shaped cell culture and the thawed sheet-shaped cell culture of the present disclosure are for use in treatment of diseases associated with tissue abnormality. The frozen sheet-shaped cell culture and the thawed sheet-shaped cell culture of the present disclosure have intrinsic properties of the constituent cells similar to those of a conventional unfrozen sheet-shaped cell culture, and, therefore, can be applied at least to those tissues and diseases which can be treated by the conventional unfrozen sheet-shaped cell culture. Examples of the tissue to be treated include, without limitation, a cardiac muscle, a cornea, a retina, an esophagus, skin, a joint, cartilage, a liver, a pancreas, gingiva, a kidney, a thyroid gland, a skeletal muscle, and a middle ear. In addition, the diseases to be treated include, without limitation, cardiac diseases (for example, myocardial damage (myocardial infarction or cardiac injury), cardiomyopathy (dilated cardiomyopathy), etc.), corneal diseases (for example, corneal epithelial stem cell deficiency, corneal injury (thermal/chemical corrosion), corneal ulcer, corneal clouding, corneal trepanation, corneal cicatrization, Stevens-Johnson syndrome, ocular pemphigoid, etc.), retinal diseases (for example, pigmentary retinopathy, age-related macular degeneration, etc.), esophageal diseases (for example, prevention of inflammation or stenosis of esophagus after esophageal surgery (removal of esophageal cancer), etc.), skin diseases (for example, skin injury (traumatic injury or burn), etc.), joint diseases (for example, degenerative arthritis, etc.), cartilage diseases (for example, cartilage injury, etc.), liver diseases (for example, chronic hepatopathy, etc.), pancreatic diseases (for example, diabetes, etc.), dental diseases (for example, periodontal disease, etc.), renal diseases (for example, renal insufficiency, renal anemia, renal osteodystrophy, etc.), thyroid diseases (for example, hypothyrosis, etc.), muscular diseases (for example, muscle injury, myositis, etc.), and middle ear diseases (for example, tympanitis, etc.).

In accordance with an exemplary embodiment, that the sheet-shaped cell culture is useful for the above-mentioned diseases is described in, for example, JP-T-2007-528755, Haraguchi et al., Stem Cells Transl Med. 2012 February; 1(2): 136-41, Sawa et al., Surg Today. 2012 January; 42(2): 181-4, Arauchi et al., Tissue Eng Part A. 2009 December; 15(12): 3943-9, Ito et al., Tissue Eng. 2005 March-April; 11(3-4): 489-96, Yaji et al., Biomaterials. 2009 February; 30(5): 797-803, Yaguchi et al., Acta Otolaryngol. 2007 October; 127(10): 1038-44, Watanabe et al., Transplantation. 2011 Apr. 15; 91(7): 700-6, Shimizu et al., Biomaterials. 2009 October; 30(30): 5943-9, Ebihara et al., Biomaterials. 2012 May; 33(15): 3846-51, Takagi et al., World J Gastroenterol. 2012 Oct. 7; 18(37): 5145-50, etc.

In accordance with an exemplary embodiment, the frozen sheet-shaped cell culture of the present disclosure, after thawing and optionally removing the cryoprotective agent, and the thawed sheet-shaped cell culture of the present disclosure, after optional removal of the cryoprotective agent, can be used for repair or regeneration of a tissue to be treated, through application thereof to the tissue to be treated, and can also be transplanted to a part (for example, subcutaneous tissue) other than the tissue to be treated, as a supply source of a biologically active agent such as hormone (for example, Arauchi et al., Tissue Eng Part A. 2009 December; 15(12): 3943-9, Shimizu et al., Biomaterials. 2009 October; 30(30): 5943-9, etc.). In addition, where the sheet-shaped cell culture is fragmented to an injectable size and the fragments are injected into a part needing treatment, a higher effect than that of an injection of a single cell suspension can also be obtained (Wang et al., Cardiovasc Res. 2008 Feb. 1; 77(3): 515-24). Therefore, such a utilizing method is possible also in the cases of the frozen sheet-shaped cell culture and the thawed sheet-shaped cell culture of the present disclosure.

In an exemplary embodiment, the frozen sheet-shaped cell culture and the thawed sheet-shaped cell culture of the present disclosure are substantially germfree. In an exemplary embodiment, the frozen sheet-shaped cell culture and the thawed sheet-shaped cell culture of the present disclosure are germfree. In an exemplary embodiment, the frozen sheet-shaped cell culture and the thawed sheet-shaped cell culture of the present disclosure have not undergone gene manipulation. In another exemplary embodiment, the frozen sheet-shaped cell culture and the thawed sheet-shaped cell culture of the present disclosure have undergone gene manipulation. Examples of gene manipulation include, without limitation, introduction of a gene for enhancing the viability, engrafting ability and/or functions or the like of the sheet-shaped cell culture and/or a gene useful for treatment of a disease. Examples of the gene to be introduced can include, without limitation, cytokine genes such as HGF gene, and VEGF gene. Besides, the frozen sheet-shaped cell culture and the thawed sheet-shaped cell culture of the present disclosure can be used jointly with components for enhancing the viability, engrafting property and/or functions or the like of the sheet-shaped cell culture or other effective components, which are useful for treatment of a disease to be treated.

Another aspect of the present disclosure relates to a medical composition containing the frozen sheet-shaped cell culture or the thawed sheet-shaped cell culture of the present disclosure.

In accordance with an exemplary embodiment, the medical composition of the present disclosure may contain various additive components, examples of which include a carrier that is pharmaceutically acceptable, components for enhancing the viability, engrafting property and/or functions or the like of the sheet-shaped cell culture, and other effective components useful for treatment of the disease to be treated, in addition to the frozen sheet-shaped cell culture and the thawed sheet-shaped cell culture of the present disclosure. As such additive components, there can be used any known ones, and persons skilled in the art are well informed about these additive components. Such additive components can be added to the thawed sheet-shaped cell culture obtained after thawing the frozen sheet-shaped cell culture of the present disclosure. In addition, the medical composition of the present disclosure can be used in combination with a component for enhancing the viability, engrafting property and/or functions of the sheet-shaped cell culture, other effective components useful for treatment of the disease to be treated. In an embodiment, the medical composition of the present disclosure is for use in treatment of a disease associated with tissue abnormality. The tissues and diseases to be treated are as described above with reference to the frozen sheet-shaped cell culture and the thawed sheet-shaped cell culture of the present disclosure.

Another aspect of the present disclosure relates to a package of a sheet-shaped cell culture (hereinafter, sometimes referred to simply as “the package”) that includes a sheet-shaped cell culture, a mesh-shaped support body or bodies that covers an upper surface and a lower surface of the sheet-shaped cell culture, and a cold-resistant film that encloses therein the sheet-shaped cell culture covered by the mesh-shaped support body or bodies.

The sheet-shaped cell culture, the mesh-shaped support body and the cold-resistant film in the package of the present disclosure are as described above with reference to the producing method of the present disclosure. In the package of the present disclosure, the sheet-shaped cell culture may be in an unfrozen state, in a frozen state, or in a thawed state obtained by thawing after freezing. The package of the present disclosure permits easy preservation, transfer, thawing and the like operations after frozen as it is, and, therefore, the package is extremely useful in clinical application of the sheet-shaped cell culture. In accordance with an exemplary embodiment, the package of the present disclosure may include information about the sheet-shaped cell culture (for example, without limitation, information on the subject from which the cells constituting the sheet-shaped cell culture are derived (the name, number or the like of the subject), lot number, date of production and date of cryopreservation of the sheet-shaped cell culture, name of production facility, name of use facility, etc.). The information may be included in any readable form, and may, without limitation, for example, be represented on a label or the like, be linked to a database through a representation such as bar code, or be recorded in or on an electronic recording medium such as integrated circuit (IC) chip.

Another aspect of the present disclosure relates to a kit (set, pack or combination) that includes the package of the present disclosure, a washing vessel, and a washing liquid (hereinafter sometimes referred to as “the package kit”). Herein, the terms “set,” “pack” and “combination” are used interchangeably with “kit” and, hence, the descriptions related to the “kit” herein apply to the “set” and the “pack.”

The package and the washing liquid in the package kit of the present disclosure are as described above with reference to the package of the present disclosure and the frozen sheet-shaped cell culture of the present disclosure, respectively. The washing vessel in the package kit of the present disclosure is not particularly restricted so long as it is capable of containing the washing liquid therein and permits the sheet-shaped cell culture to be immersed in the washing liquid; for example, a dish or plate for cell cultivation, or a vessel having a similar shape or function to that of the dish or plate, or the like can be used as the washing vessel. The washing liquid may be provided in a liquid state (ready-to-use form), or may be provided in a form permitting preparation at the time of use. Examples of the form permitting preparation at the time of use include, without limitation, a form in which a solid component and a liquid component are provided in separate containers, and they are mixed, at the time of use, with each other to prepare the washing liquid.

In addition to the above-mentioned, the package kit of the present disclosure may include instruments (for example, scissors, knife, pipette, dropping pipette, tweezers, etc.), a waste liquid recovery vessel, instructions related to the use method of the kit (for example, an instruction book, a medium such as flexible disc, CD, DVD, Blu-ray Disc, memory card, USB memory or the like on which information about the use method is recorded, etc.), or the like.

The package kit of the present disclosure can be used for treatment of a subject by the sheet-shaped cell culture. More specifically, for example, a process may be performed wherein the package kit of the present disclosure is transferred to a facility for treatment while keeping the sheet-shaped cell culture contained in the package in the frozen state, the frozen sheet-shaped cell culture contained in the package of the present disclosure is thawed as it is in the package at the facility, the cold-resistant film is opened by, for example, the scissors or knife belonging to the kit, the thawed sheet-shaped cell culture supported by the mesh-shaped support body is taken out of the package by use of, for example, tweezers or the like belonging to the kit, and is immersed in the washing liquid contained in the washing vessel to remove the cryoprotective agent, whereby the sheet-shaped cell culture thus obtained can be applied to an affected part of the subject to be treated, while keeping the sheet-shaped cell culture supported by the mesh-shaped support body. A process may also be performed wherein the cold-resistant film is opened before thawing the package, the sheet-shaped cell culture in the frozen state supported by the mesh-shaped support body is taken out, and is immersed in the washing liquid contained in the washing vessel, whereby the thawing of the sheet-shaped cell culture and the removal of the cryoprotective agent can be conducted simultaneously. According to the package kit of the present disclosure, a series of operations of thawing the frozen sheet-shaped cell culture, removing the cryoprotective agent and applying the sheet-shaped cell culture to the subject can be carried out relatively easily.

Another aspect of the present disclosure relates to a method of treating a disease associated with tissue abnormality in a subject (hereinafter sometimes referred to simply as “the treating method”) that includes a step of administering an effective amount of the thawed sheet-shaped cell culture of the present disclosure to the subject in need thereof.

The tissue or disease to be treated in the treating method of the present disclosure is as described above with reference to the thawed sheet-shaped cell culture of the present disclosure. In addition, in the treating method of the present disclosure, components for enhancing the viability, engrafting property and/or functions or the like of the sheet-shaped cell culture, other effective components useful for treatment of the disease to be treated, and the like can be used in combination with the thawed sheet-shaped cell culture. The thawed sheet-shaped cell culture to be used in the treating method of the present disclosure may be one that is obtained by removal of the cryoprotective agent after thawing of the frozen sheet-shaped cell culture of the present disclosure. The removal of the cryoprotective agent is as described above with reference to the frozen sheet-shaped cell culture of the present disclosure. In addition, the thawed sheet-shaped cell culture to be used in the treating method of the present disclosure may be included in the medical composition of the present disclosure. Therefore, the matter to be administered in the treating method of the present disclosure may be the medical composition of the present disclosure that includes the thawed sheet-shaped cell culture of the present disclosure.

In the present disclosure, the term “subject” means any organism individual, preferably an animal, more preferably a mammal, and further preferably a human individual. In the present disclosure, the subject may be healthy, or may be suffering from some disease; in the case where it is intended to treat a disease associated with tissue abnormality, for example, the subject means a subject who is suffering from the disease or has a risk of suffering the disease.

In addition, the term “treatment” includes all kinds of medically acceptable preventive and/or therapeutic interventions for the purpose of curing, temporary remission or prevention of a disease or the like. For example, the term “treatment” can include medically acceptable interventions for various purposes, inclusive of delaying or stopping of progress of a disease associated with tissue abnormality, recession or disappearance of a lesion, prevention of onset of a disease or prevention of recurrence of a disease, and the like.

In the present disclosure, the effective amount is, for example, an amount (for example, size or weight of a sheet-shaped cell culture) that enables restraining onset or recurrence of a disease, alleviation of a symptom, or delaying or stopping of progress of a disease, preferably an amount for preventing onset or recurrence of the disease or for curing the disease. In addition, an amount that does not produce a bad influence in excess of the merit of administration is preferred. Such an amount can be appropriately determined, for example, by experiments on experimental animals such as mice, rats, dogs or pigs or disease model animals or the like, and such experimental methods are well known to persons skilled in the art. In addition, the size of the tissue lesion to be treated can be an important index for determination of the effective amount.

As an administering method, direct application to tissue may be mentioned typically. In the case of using fragments of the sheet-shaped cell culture, the fragments may be administered through various routes permitting administration by injection, such as intravenous, intramuscular, subcutaneous, local, intraarterial, intraportal, intraventricular, and intraperitoneal routes.

The frequency of administration can be, for example, once per treatment; when this is not enough to obtain a desired effect, however, the administration may be carried out multiple times.

The treating method of the present disclosure may include a step of taking out the sheet-shaped cell culture covered by the mesh-shaped support body or bodies from the package of the present disclosure, before the administration step. The taking-out step may be conducted, for example, without limitation, by a method in which the cold-resistant film of the package of the present disclosure including the thawed sheet-shaped cell culture is opened, and the thawed sheet-shaped cell culture covered by the mesh-shaped support body or bodies is taken out therefrom, or by a method in which the cold-resistant film of the package of the present disclosure including the frozen sheet-shaped cell culture is opened, and the frozen sheet-shaped cell culture covered by the mesh-shaped support body or bodies is taken out therefrom. In the former case, a step of thawing the frozen sheet-shaped cell culture in the package may be included before the taking-out step. The thawing step can be achieved, for example, without limitation, by a method in which the package of the present disclosure including the frozen sheet-shaped cell culture is served to thawing means, such as a solid, liquid or gaseous medium (for example, water), a water bath, an incubator, a thermostat, a hot plate or the like at a temperature higher than the freezing temperature, or by a method in which the package is immersed in a thawing medium (for example, culture solution) at a temperature higher than the freezing temperature. The temperature of the thawing means or the thawing medium and the thawing time are as described above with reference to the frozen sheet-shaped cell culture of the present disclosure. In the latter case, a step of thawing the frozen sheet-shaped cell culture may be included after the taking-out step. The thawing technique for the frozen sheet-shaped cell culture is as described above with reference to the frozen sheet-shaped cell culture. In addition, non-limited examples of the taking-out step are represented above in relation to the package kit of the present disclosure.

In an exemplary embodiment, the treating method of the present disclosure may include a step of thawing the frozen sheet-shaped cell culture of the present disclosure, before the administration step. The thawing technique for the frozen sheet-shaped cell culture of the present disclosure is as described above with reference to the frozen sheet-shaped cell culture of the present disclosure.

In the case where the treating method of the present disclosure includes the step of thawing the frozen sheet-shaped cell culture, a step of removing the cryoprotective agent may be included, as required, after the thawing step. The removal of the cryoprotective agent is as described above with reference to the frozen sheet-shaped cell culture of the present disclosure.

In an exemplary embodiment, the treating method of the present disclosure includes:

(A1) a step of taking out a sheet-shaped cell culture covered by a mesh-shaped support body or bodies, from the package of the present disclosure; and

(A2) a step of administering an effective amount of the thawed sheet-shaped cell culture to a subject in need thereof (hereinafter sometimes referred to as “the treating method A”).

In an exemplary embodiment, the sheet-shaped cell culture in the step A1 is a thawed one (hereinafter sometimes referred to as “the treating method A′”). The treating method A′ of the present disclosure may include a step of thawing the frozen sheet-shaped cell culture included in the package of the present disclosure (step A1-1), before taking out the sheet-shaped cell culture covered by the mesh-shaped support body or bodies. In an exemplary embodiment, the sheet-shaped cell culture in the step A1 is in a frozen state (hereinafter sometimes referred to as “the treating method A″”). The treating method A″ of the present disclosure may include a step of thawing the frozen sheet-shaped cell culture (step A1-2), after the step (A1). In addition, the treating method A of the present disclosure may include a step of removing the cryoprotective agent from the thawed sheet-shaped cell culture (step A1-3).

Therefore, in an embodiment, the treating method A′ includes the steps A1-1, A1 and A2. In an exemplary embodiment, the treating method A′ of the present disclosure includes the steps A1-1, A1, A1-3 and A2. In another exemplary embodiment, the treating method A″ of the present disclosure includes the steps A1, A1-2 and A2. In an exemplary embodiment, the treating method A″ of the present disclosure includes the steps A1, A1-2, A1-3 and A2.

In accordance with an exemplary embodiment, the treating method of the present disclosure includes:

(B1) a step of thawing the frozen sheet-shaped cell culture of the present disclosure; and

(B2) a step of administering an effective amount of the thawed sheet-shaped cell culture to a subject in need thereof (hereinafter sometimes referred to as “the treating method B”).

In accordance with an exemplary embodiment, the treating method B of the present disclosure may include a step of removing the cryoprotective agent from the thawed sheet-shaped cell culture (step B1-1), after the step (B1).

The treating method of the present disclosure may further include a step of producing a frozen sheet-shaped cell culture, according to the producing method of the present disclosure. The treating method of the present disclosure may further include a step of harvesting, from a subject, cells for producing the sheet-shaped cell culture or a tissue serving as a supply source of the cells, before the step of producing the sheet-shaped cell culture. In an exemplary embodiment, the subject from which the cells or the tissue serving as a supply source of the cells is to be harvested is the same individual as a subject to which the sheet-shaped cell culture is to be administered. In another exemplary embodiment, the subject from which the cells or the tissue serving as a supply source of the cells is to be harvested is a different individual of the same species as that of the subject to which the sheet-shaped cell culture is to be administered. In another exemplary embodiment, the subject from which the cells or the tissue serving as a supply source of the cells is to be harvested is an individual of a different species as that of the subject to which the sheet-shaped cell culture is to be administered.

Another aspect of the present disclosure relates to a cryopreservation vessel for a sheet-shaped cell culture (hereinafter sometimes referred to simply as the cryopreservation vessel”) that includes: a mesh-shaped support body or bodies capable of covering an upper surface and a lower surface of the sheet-shaped cell culture; and a cold-resistant film capable of enclosing therein the sheet-shaped cell culture covered by the mesh-shaped support body or bodies.

The mesh-shaped support body or bodies and the cold-resistant film in the cryopreservation vessel of the present disclosure are as described above with reference to the producing method of the present disclosure. The cryopreservation vessel of the present disclosure is suitable for cryopreserving a sheet-shaped cell culture, particularly, for example, a fragile sheet-shaped cell culture, for a long period without causing deterioration of quality. The cryopreservation vessel of the present disclosure may further include a case for accommodating the cold-resistant film that encloses the sheet-shaped cell culture therein and for protecting it from external shocks or the like. The case may be configured to be able to accommodate one or more cold-resistant films enclosing the sheet-shaped cell culture therein.

Another aspect of the present disclosure relates to a kit comprising: a mesh-shaped support body or bodies capable of covering an upper surface and a lower surface of a sheet-shaped cell culture; a cold-resistant film capable of enclosing therein the sheet-shaped cell culture covered by the mesh-shaped support body or bodies; and a cryopreservation solution (hereinafter sometimes referred to simply as “the freezing kit”).

The mesh-shaped support body or bodies, the cold-resistant film and the cryopreservation solution in the freezing kit of the present disclosure are as described above with reference to the producing method of the present disclosure. The cryopreservation solution may be provided in a liquid state containing all components (ready-to-use form), or may be provided in a form permitting preparation at the time of use. Examples of the form permitting preparation at the time of use include, without limitation, a form in which a solid component and a liquid component are provided in separate containers, and they are mixed, at the time of use, with each other to prepare the washing liquid.

In addition to the above-mentioned, the freezing kit of the present disclosure may include an immersion vessel, a waste liquid recovery vessel, instruments (for example, pipette, dropping pipette, tweezers, etc.), instructions related to the use method of the kit (for example, an instruction book, a medium such as flexible disc, CD, DVD, Blu-ray Disc, memory card, USB memory or the like on which information about the use method is recorded, etc.).

The freezing kit of the present disclosure can be used for freezing of a sheet-shaped cell culture, production of a frozen sheet-shaped cell culture, or the like. More specifically, for example, a process can be performed wherein, for example, a sheet-shaped cell culture isolated from a culture substrate is scooped up from a culture vessel by a mesh-shaped support body, the sheet-shaped cell culture supported by the mesh-shaped support body is immersed in a cryopreservation solution contained in the immersion vessel for a predetermined time, and then taken out of the immersion vessel, the unnecessary cryopreservation solution adhered to the sheet-shaped cell culture is removed through the mesh-shaped support body, an upper surface and a lower surface of the sheet-shaped cell culture are covered by a mesh-shaped support body or bodies, the whole thereof is enclosed in the cold-resistant film, and is subjected to rapid freezing in the state of being enclosed in the film. According to the freezing kit of the present disclosure, a series of operations of immersing the sheet-shaped cell culture in the cryopreservation solution, removing the surplus cryopreservation solution, and performing freezing can be carried out easily.

### EXAMPLES

The present disclosure will be described in detail below referring to Examples, but they merely represent specific examples of the present disclosure and are not restrictive of the disclosure.

### Example 1: Producing and Preserving Methods for Myoblast Sheet

### Test Example 1: Production of Sheet-Shaped Cell Culture [1]

Skeletal myoblasts prepared from human skeletal muscle by an ordinary method were suspended in a 20% human serum-containing DMEM-F12 medium (made by Life Technologies Corporation), were seeded on a temperature-responsive culture dish (UpCell (registered trademark) 10-cm dish, made by CellSeed Inc.) in a density of 4×105 cells/cm², and were subjected to sheet-formation cultivation in an environment of 37° C. and 5% CO2 for 16 hours.

### Test Example 2: Cryopreservation Using Paper-Formed Support Body

Cryopreservation was conducted according to the technique described in Maehara et al., BMC Biotechnol. 2013 Jul. 25; 13: 58. After the sheet-formation cultivation of Test Example 1, the medium was removed from the culture dish, a paper-formed support body (CellShifter for 10-cm dish, made by CellSeed Inc.) was laid over the sheet-shaped cell culture adhering to the culture dish, and, after left to stand at room temperature for 5 minutes, the sheet-shaped cell culture was peeled from the culture dish together with the paper-formed support body. The sheet-shaped cell culture supported by the paper-formed support body was immersed for 5 minutes in an equilibrium solution (prepared by adding 10% (v/v) of DMSO and 10% (v/v) of ethylene glycol to a basal solution (Tissue Culture Medium-199 (made by Nissui Pharmaceutical Co., Ltd.) containing 20 mM of Hepes and 20% of calf serum)) contained in a dish, was thereafter transferred to another dish containing an equilibrium solution of the same composition, and was immersed in the equilibrium solution for 20 minutes for equilibration. Then, the sheet-shaped cell culture was transferred to another dish containing a cryopreservation solution (prepared by adding 20% (v/v) of DMSO, 20% (v/v) of ethylene glycol, 0.5 M of sucrose, and 10% (w/v) of carboxylated poly-L-lysine (COOH-PLL) to the basal solution), to be immersed in the cryopreservation solution for 5 minutes, and was then transferred to another dish containing a cryopreservation solution of the same composition, to be immersed in the cryopreservation solution for 15 minutes. During this series of immersing operation, breakage of the sheet-shaped cell culture was observed frequently. The broken sheet-shaped cell culture was discarded, without being served to later treatments. The sheet-shaped cell culture was taken out of the vitrification solution, was enclosed in a film (NEW Krewrap®, made by Kureha Corporation) together with the paper-formed support body, and the periphery of the film was fused for hermetic sealing. The sheet-shaped cell culture enclosed in the film was subjected to rapid freezing by holding sheet-shaped cell culture enclosed in the film horizontally on a scaffold disposed such that an upper surface was located at approximately 1 cm above liquid nitrogen, for approximately 20 minutes, and was then preserved in liquid nitrogen.

### Test Example 3: Cryopreservation Using Mesh-Shaped Support Body [1]

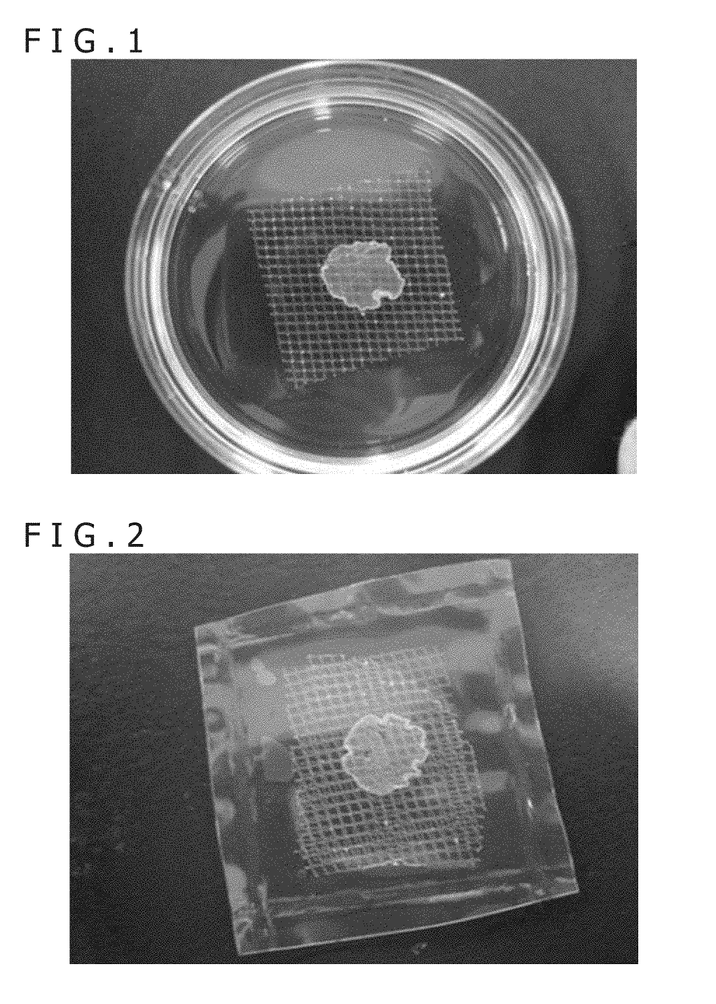

After the sheet-formation cultivation of Test Example 1, the sheet-shaped cell culture was peeled from the culture dish by a temperature treatment to room temperature, was then scooped up with a surgical mesh (TiLENE® MESH extralight, made by pfm medical ag.), and was immersed in a cryopreservation solution (StemCell Keep, made by BioVerde Inc.) containing carboxylated poly-L-lysine for 5 minutes (FIG. 1). The mesh was composed of polypropylene monofilament having a surface coated with titanium (weight: 16 g/m2, thickness: 0.20 mm, mesh opening: ≧1 mm, filament diameter: 65 μm, two-dimensional aperture ratio: 73%, three-dimensional aperture ratio: 91%, elasticity at 16 N/cm: 34%). Next, the sheet-shaped cell culture was taken out of the cryopreservation solution, and, after removal of the adhering cryopreservation solution, the sheet-shaped cell culture was placed on the film while kept supported by the mesh. An upper surface of the sheet-shaped cell culture was covered with another mesh, the sheet-shaped cell culture sandwiched between two sheets of meshes was enclosed in a film (Hybri-Bag, made by Cosmo Bio Co., Ltd.) together with the meshes, and the periphery of the film was fused for hermetic sealing (FIG. 2). The sheet-shaped cell culture enclosed in the film was subjected to rapid freezing by holding the sheet-shaped cell culture enclosed in the film horizontally on a scaffold disposed such that an upper surface was located at approximately 1 cm above liquid nitrogen, for approximately 5 minutes, and was then preserved in liquid nitrogen. Note that unlike in Test Example 2, the sheet-shaped cell culture was not broken during the cryopreserving operation.

### Test Example 4: Evaluation of Sheet-Shaped Cell Culture after Thawing [1]

(1) Where Paper-Formed Support Body was Used

The frozen sheet-shaped cell culture obtained in Test Example 2 was thawed by disposing the frozen sheet-shaped cell culture, in the state of being enclosed in the film, on a hot plate (approximately 37° C. to 38° C.) for approximately 90 seconds. The sheet-shaped cell culture was taken out of the film together with the paper-formed support body, and the cryopreservation solution was diluted and removed according to the technique described in Maehara et al., BMC Biotechnol. 2013 Jul. 25; 13: 58. Specifically, the sheet-shaped cell culture supported by the paper-formed support body was first immersed in a rewarming solution (prepared by adding 1 M of sucrose to the basal solution) for 1 minute, was then transferred into and immersed for 3 minutes in a dilution solution (prepared by adding 0.5 M of sucrose to the basal solution), was then immersed in a washing solution (the basal solution), and was finally immersed again in another washing solution of the same composition. During immersion in each solution, the sheet-shaped cell culture was lightly shaken, for accelerating diffusion of the cryoprotective agent.

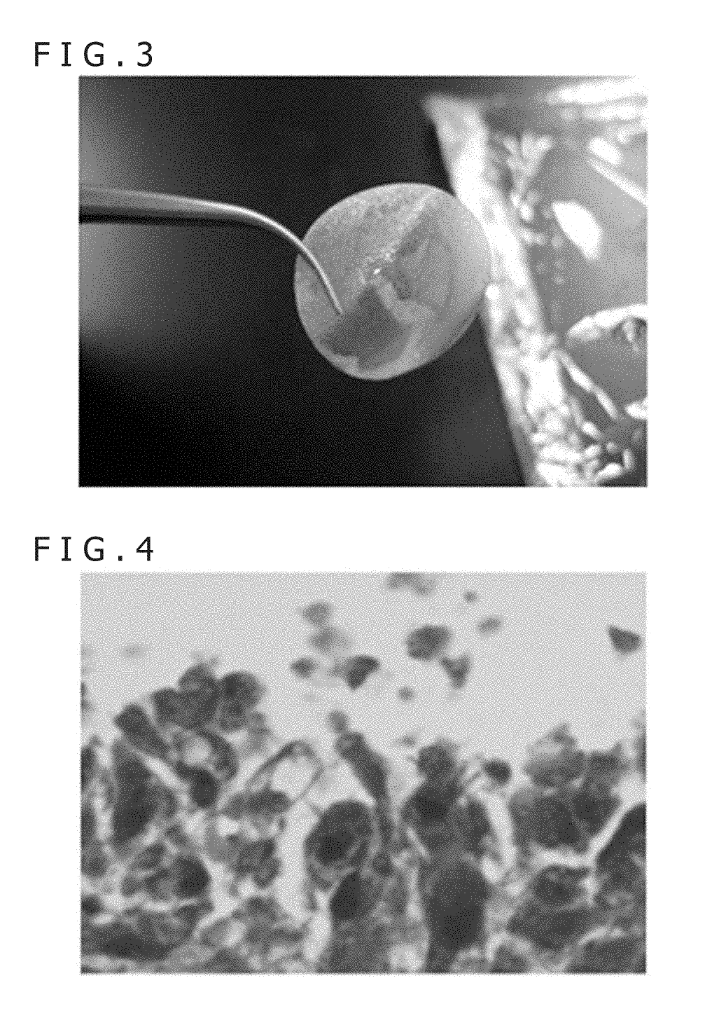

During when the sheet-shaped cell culture was taken out from the film together with the paper-formed support body, breakage of the sheet-shaped cell culture was frequently observed (FIG. 3). This is considered to be due to, for example, adhesion of part of the sheet-shaped cell culture to the film. In addition, when the sheet-shaped cell culture after thawing was fixed, sliced and HE stained according to ordinary methods and observed under an optical microscope, damaging of the sheet surface, separation of intercellular adhesion and the like were observed (FIG. 4).

(2) Where Mesh-Shaped Support Body was Used

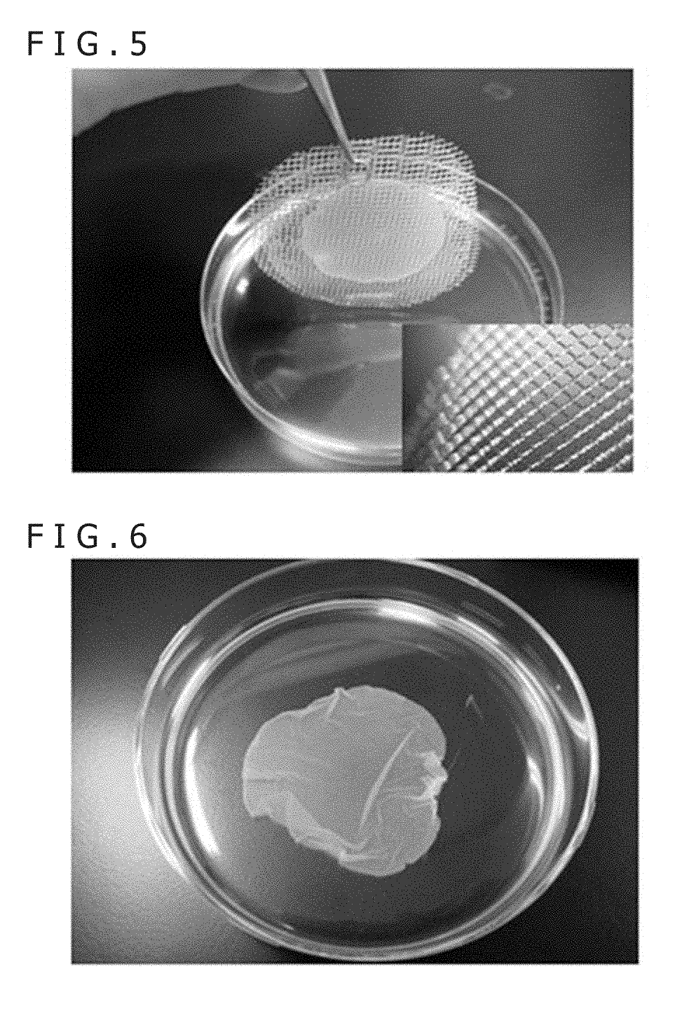

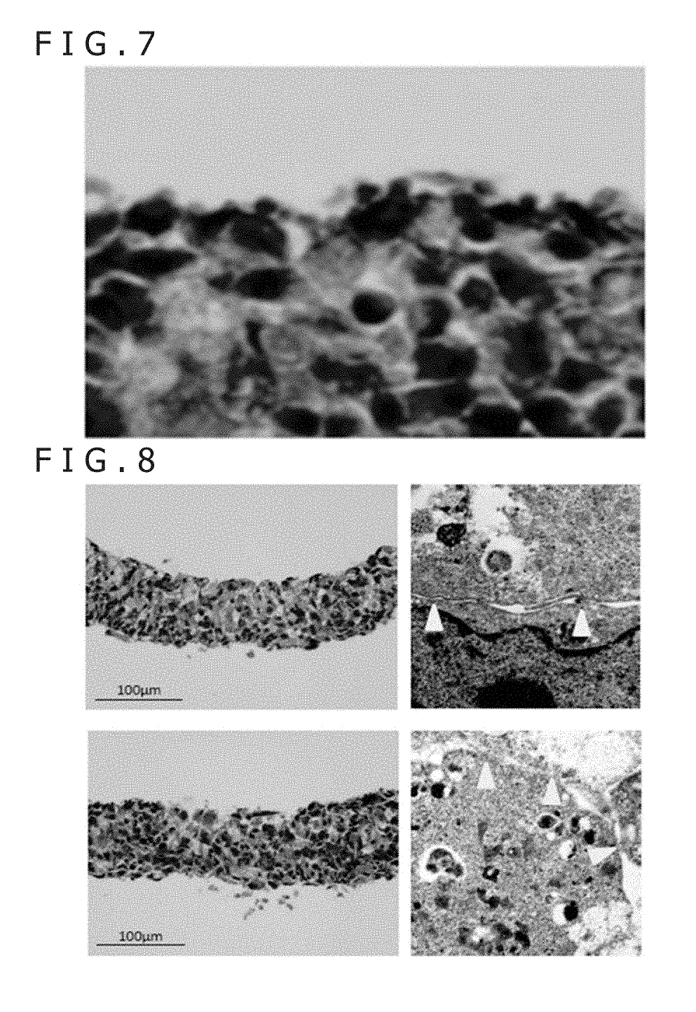

The frozen sheet-shaped cell culture obtained in Test Example 2 was thawed by disposing the frozen sheet-shaped cell culture, in the state of being enclosed in the film, on a hot plate (approximately 37° C. to 38° C.) for approximately 90 seconds. The sheet-shaped cell culture was taken out from the film while kept sandwiched between the meshes (FIG. 5), and was immersed once in HBSS(+), to remove the cryoprotective agent. As represented in FIG. 6, the sheet-shaped cell culture was free of damages visible to the naked eye, even after served to a series of freezing and thawing operations. In addition, when the sheet-shaped cell culture after thawing was fixed, sliced and HE stained according to ordinary methods and observed under an optical microscope, neither damaging of the sheet surface nor separation of intercellular adhesion was observed (FIG. 7).

### Test Example 5: Evaluation of Influences of Cryopreservation on Sheet-Shaped Cell Culture [1]

In order to evaluate influences of the cryopreserving method of the present disclosure on a sheet-shaped cell culture, the following experiments were conducted using the sheet-shaped cell culture obtained before the freezing of Test Example 3 and the frozen sheet-shaped cell culture obtained in Test Example 3.

(1) Intercellular Adhesion

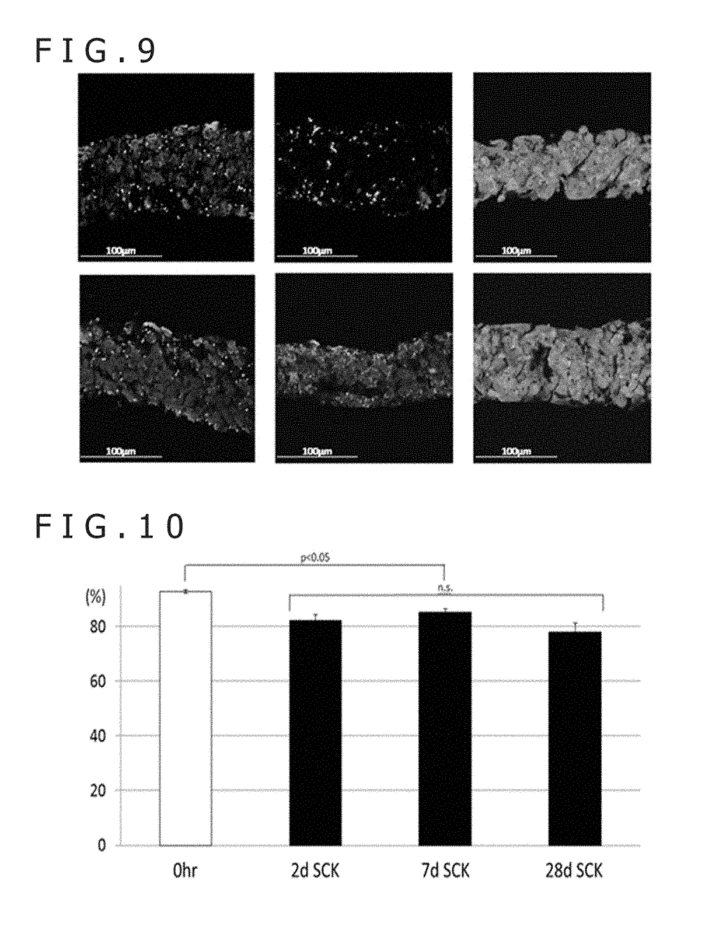

In order to evaluate intercellular adhesion in a sheet-shaped cell culture before freezing and that after thawing, a sheet-shaped cell culture before freezing and a sheet-shaped cell culture thawed after cryopreserved for two days were fixed, sliced and HE stained according to ordinary methods and observed under an optical microscope, whereon it was confirmed that a tissue structure was maintained (FIG. 8, photographs on the left side). In addition, when the same sheet-shaped cell cultures were observed under an electron microscope according to an ordinary method, desmosome indicating that the intercellular adhesion was maintained was confirmed also on the sample after thawing (FIG. 8, photographs on the right side). Further, when the same sheet-shaped cell cultures were subjected to immunostaining according to an ordinary method in regard of fibronectin, collagen IV or N-cadherin serving as an intercellular matrix component, no difference was observed between the state before freezing and the state after thawing (FIG. 9). Note that antibodies used here are as set forth in the following table.

TABLE 1
Antibodies used for immunostaining of intercellular matrix components

| | | | | Product |
|---|---|---|---|---|
| | Name of antibody | Host | Maker | No. |
| Primary | Anti-fibronectin antibody | mouse | abcam | ab6328 |
| antibody | Anti-collagen IV antibody | mouse | abcam | ab6311 |
| | Anti-N-cadherin antibody | rabbit | abcam | ab12221 |
| Secondary | Alexa Fluor ® 488 labeled | donkey | Life | A21206 |
| antibody | Anti-rabbit IgG antibody | | Technologies | |
| | Alexa Fluor ® 488 labeled | donkey | Life | A21202 |
| | Anti-mouse IgG antibody | | Technologies | |

(2) Cell Survival Rate

Sheet-shaped cell cultures before freezing or upon thawing after cryopreservation for two days, seven days or 28 days were processed into single cells by TrypLE™ Select (made by Life Technologies Corporation), and were stained with trypan blue, after which live cells were counted by an automated cell counter (Countess™ Automated Cell Counter, made by Life Technologies Corporation), to evaluate cell survival rate (n=4). For statistical evaluation, t test was used. The results are represented in FIG. 10. While the survival rate before freezing was 92.9%, the survival rate after thawing was maintained at approximately 80%, and a lowering in survival rate according to a preservation period was not observed.

(3) Apoptosis

In order to evaluate apoptosis in a sheet-shaped cell culture before freezing and that after thawing, a sheet-shaped cell culture before freezing and a sheet-shaped cell culture thawed after cryopreserved for two days were served to immunostaining by use of apoptosis-related proteins (caspases 3, 8 and 9) and ss-DNA and to TUNEL staining according to ordinary methods. For the immunostaining, the primary antibodies and secondary antibodies set forth in the following table were individually used. In addition, for TUNEL staining, there was used Click-iT® TUNEL Alexa Fluor®) 647 Imaging Assay, for microscopy & HCS (catalog No.: C10247, made by Life Technologies Corporation).

TABLE 2
Antibodies used for immunostaining

| | | | | Product |
|---|---|---|---|---|
| | Name of antibody | Host | Maker | No. |
| Primary | Anti-caspase 3 antibody | mouse | NeoMarkers | MS-1123- |
| antibody | | | | PABX |
| | Anti-caspase 8 antibody | rabbit | Novus | NB600- |
| | | | Biologicals | 576 |
| | Anti-caspase 9 antibody | rabbit | abcam | ab2324 |
| | Anti-ssDNA antibody | mouse | abcam | ab79439 |
| Secondary | Alexa Fluor ® 488 labeled | donkey | Life | A21206 |
| antibody | Anti-rabbit IgG antibody | | Technologies | |
| | Alexa Fluor ® 488 labeled | donkey | Life | A21202 |
| | Anti-mouse IgG antibody | | Technologies | |

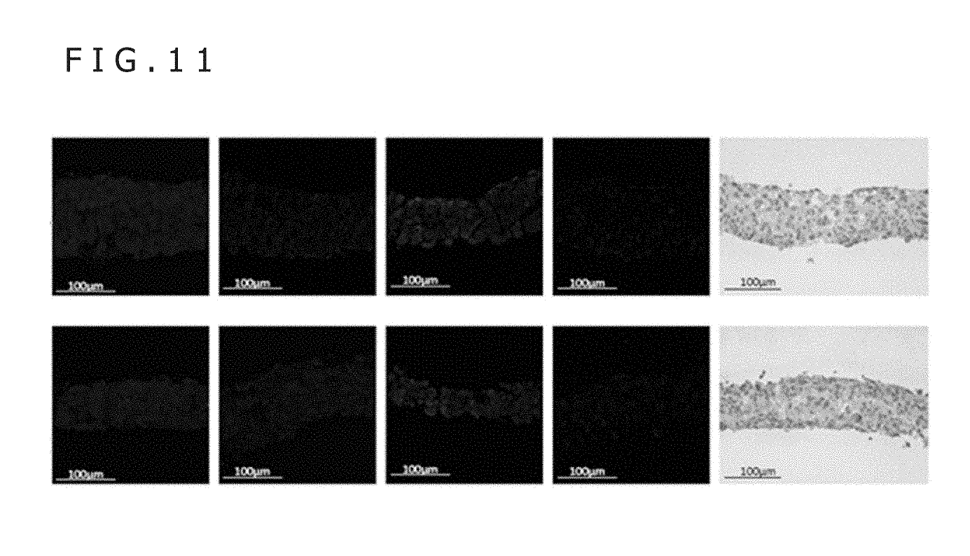

As represented by the results of FIG. 11, generation of apoptosis was not observed.

(4) Mitochondria Activity

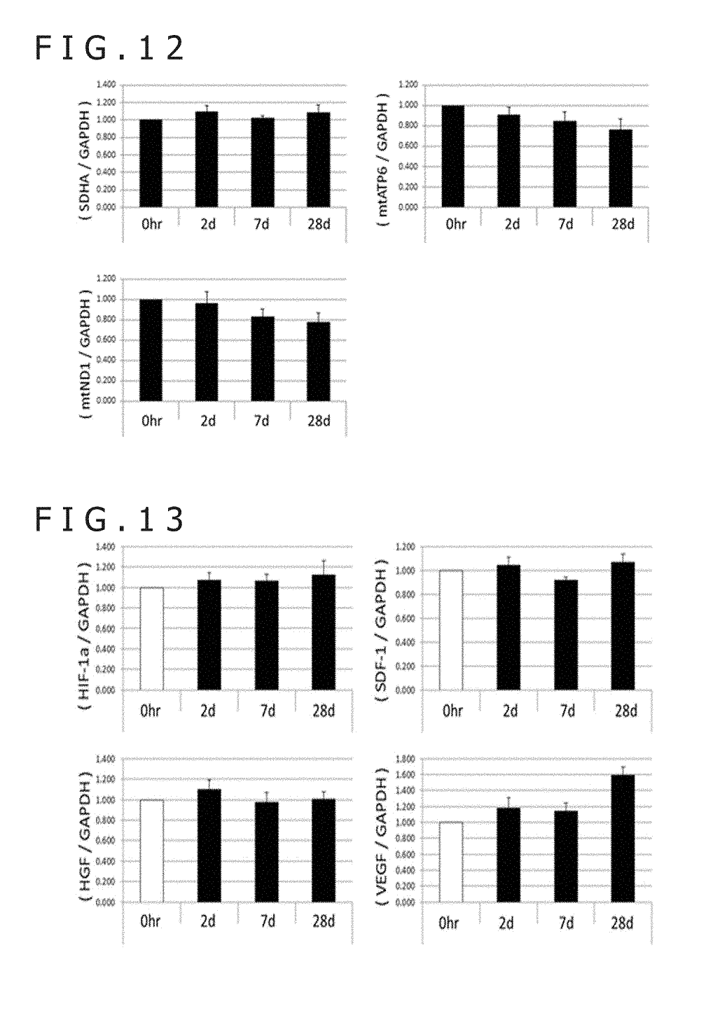

In order to evaluate mitochondria activity in a sheet-shaped cell culture before freezing and that after thawing, gene expression of mitochondria-related proteins (SDHA, mtATP6 and mtND1) in sheet-shaped cell cultures before freezing or upon thawing after cryopreservation for two days, seven days or 28 days was evaluated by real-time PCR by TaqMan® Gene Expression Assay (catalog No.: 4331182, made by Life Technologies Corporation) (Assay IDs of SDHA, mtATP6 and mtND1 are Hs00188166_m1, Hs02596862_g1 and Hs02596873_s1 respectively). Note that GAPDH (Assay ID: Hs03929097_g1) was used as an internal standard, and t test was used for statistical evaluation. As represented by the results of FIG. 12, no difference in mitochondria activity was observed between the state before freezing and the state after thawing.

(5) Cytokine Expression

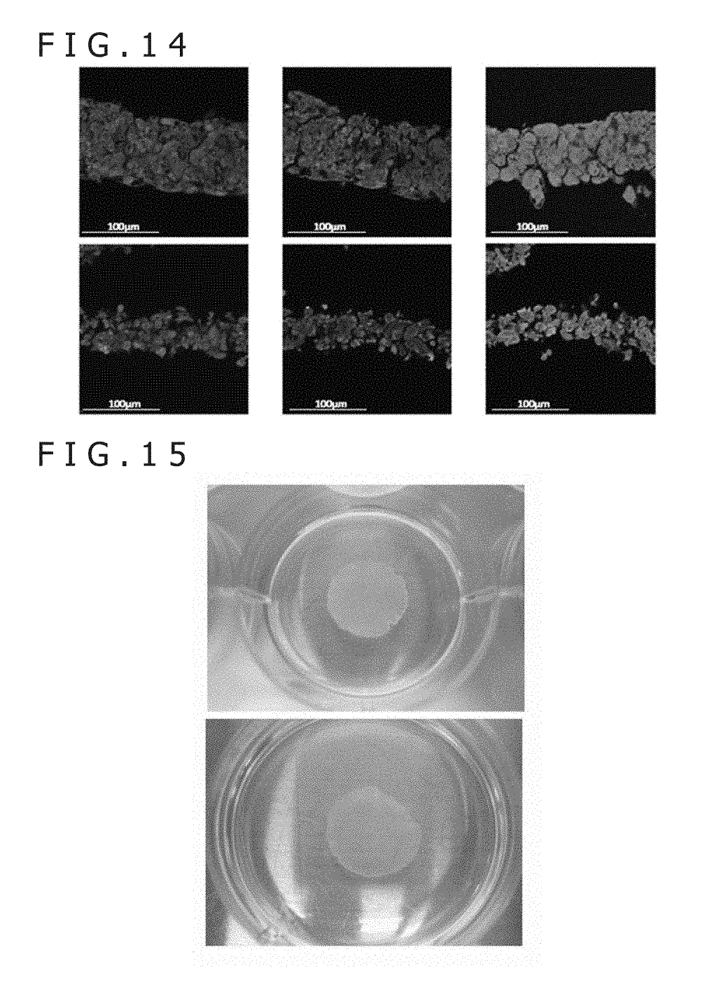

In order to evaluate expression of cytokines in a sheet-shaped cell culture before freezing and that after thawing, gene expression of cytokines (HIF-1α, SDF-1, HGF and VEGF) in sheet-shaped cell cultures before freezing or upon thawing after cryopreservation for two days, seven days or 28 days was evaluated by real-time PCR by TaqMan® Gene Expression Assay (catalog No.: 4331182, made by Life Technologies Corporation) (Assay IDs of HIF-1α, SDF-1, HGF and VEGF are Hs00153153_m1, Hs03676656_mH, Hs00300159_m1 and Hs00900055_m1, respectively). Note that GAPDH (Assay ID: Hs03929097_g1) was used as an internal standard, and t test was used for statistical evaluation. As represented by the results of FIG. 13, no difference in cytokine expression was observed between the state before freezing and the state after thawing. In addition, when the sheet-shaped cell culture before freezing and the sheet-shaped cell culture thawed after cryopreserved for two days were subjected to immunostaining in regard of VEGF, HIF-1α and HGF according to an ordinary method, no difference was observed between the state before freezing and the state after thawing (FIG. 14). Note that the antibodies used are as set forth in the following table.

TABLE 3
Antibodies used for immunostaining of cytokines

| | | | | Product |
|---|---|---|---|---|
| | Name of antibody | Host | Maker | No. |
| Primary | Anti-VEGF antibody | rabbit | abcam | ab46154 |
| antibody | Anti-HIF-1α antibody | mouse | abcam | ab8366 |
| | Anti-HGF antibody | rabbit | abcam | ab83760 |
| Secondary | Alexa Fluor ® 488 labeled | donkey | Life | A21206 |
| antibody | Anti-rabbit IgG antibody | | Technologies | |
| | Alexa Fluor ® 488 labeled | donkey | Life | A21202 |
| | Anti-mouse IgG antibody | | Technologies | |

The above results represent that fragile sheet-shaped cell cultures composed of skeletal myoblasts or the like can also be cryopreserved for a long period without deterioration of quality, according to the method of the present disclosure.

### Example 2: Producing and Preserving Methods for iPS-Derived Myocardial Cell Sheet

### Test Example 6: Production of Sheet-Shaped Cell Culture [2]

(1) Derivation of Myocardial Cells from Human iPS Cells

Human iPS cells (253G1 strain) were purchased from Riken BioResource Center, and were maintained on mouse embryo fibroblasts (MEF, made by ReproCELL Inc.) subjected to a mitomycin C treatment, in a Primate ES Cell Medium (made by ReproCELL Inc.) to which 5 ng/mL of basic fibroblast growth factor (bFGF, made by ReproCELL Inc., here and hereinafter) had been added, in a culture dish having a diameter of 10 cm. Subculture of the cells was conducted every three to four days by use of a cell peeling liquid (CTK solution, made by ReproCELL Inc., here and hereinafter) while maintaining a colony (without conversion into a single cell suspension).

Derivation of myocardial cells was conducted by making predetermined additives act on embryoid body (EB) in suspension culture at predetermined timings. Human iPS cell aggregates (approximately 2×107 cells) peeled from ten culture dishes by the cell peeling liquid were re-suspended in 100 mL of mTeSR (trademark)1 (made by STEMCELL Technologies Inc.) to which 10 μM of a ROCK inhibitor (Y-27632, made by Wako Pure Chemical Industries, Ltd.) had been added, and were introduced into a culture apparatus provided with stirrer (Bio Jr. 8, made by Able Corporation). During the culture, the stirring rate was kept at 40 rpm, the dissolved oxygen concentration was kept at 40%, pH was kept at 7.2, and temperature was kept at 37° C. Control of the dissolved oxygen concentration was conducted by use of air, oxygen, or nitrogen, and control of pH was performed by addition of CO2.

After one day (on first day) of the start of culture (zeroth day) in a culture apparatus, the medium was replaced with a basal medium for myocardial cell derivation (StemPro (registered trademark)-34 SFM (made by Life Technologies Corporation) including 50 μg/mL of ascorbic acid (made by Sigma-Aldrich Co. LLC.), 2 mM of L-glutamine and 400 μM of 1-thioglycerol (made by Sigma-Aldrich Co. LLC.)) to which 0.5 ng/mL of BMP4 (made by R&D Systems, Inc., here and hereinafter) had been added. Thereafter, the medium was replaced with the basal media for myocardial cell derivation including the following additives at the following timings. Second day: 10 ng/mL of BMP4, 5 ng/mL of bFGF, and 3 ng/mL of activin A (made by R&D Systems, Inc.), fifth day: 4 μM of Wnt signal inhibitor (IWR-1-endo, made by Wako Pure Chemical Industries, Ltd.), seventh day: 5 ng/mL of VEGF (made by R&D Systems, Inc.) and 10 ng/mL of bFGF. Thereafter, medium replacement was conducted on ninth, 11th, 13th and 15th days by use of the same medium as used on seventh day (namely, the basal medium for myocardial cell derivation to which 5 ng/mL of VEGF and 10 ng/mL of bFGF had been added). In this manner, a cell population (cell mass) including myocardial cells derived from human iPS cells was obtained. The cell population was dissociated by 0.05% trypsin/EDTA, after which the remaining cell aggregates were removed by use of a strainer (made by BD Biosciences).

(2) Sheet-Formation Cultivation of Myocardial Cells

A sheet-shaped cell culture was produced according to the method of Test Example 1, except that the dissociated cell population obtained in the preceding step (1) was used and the culture period was five days.

### Test Example 7: Cryopreservation Using Mesh-Shaped Support Body [2]

The sheet-formed cell culture obtained in Test Example 6 (2) was peeled from the culture dish after confirmation of pulsation, and was cryopreserved according to the method of Test Example 3.

### Test Example 8: Evaluation of Sheet-Shaped Cell Culture after Thawing [2]

The frozen sheet-shaped cell culture obtained in Test Example 7 was thawed and the cryoprotective agent was removed, according to the method of Test Example 4 (2). As represented in FIG. 15, both before freezing (top) and after the series of freezing and thawing operations (bottom), breakage visible to the naked eye was not observed on the sheet-shaped cell culture.

### Test Example 9: Evaluation of Influences of Cryopreservation on Sheet-Shaped Cell Culture [2]

In order to evaluate influences of the cryopreserving method of the present disclosure on a sheet-shaped cell culture, the following experiments were conducted using the sheet-shaped cell culture obtained before the freezing of Test Example 7 and the frozen sheet-shaped cell culture obtained in Test Example 7.

(1) Intercellular Adhesion

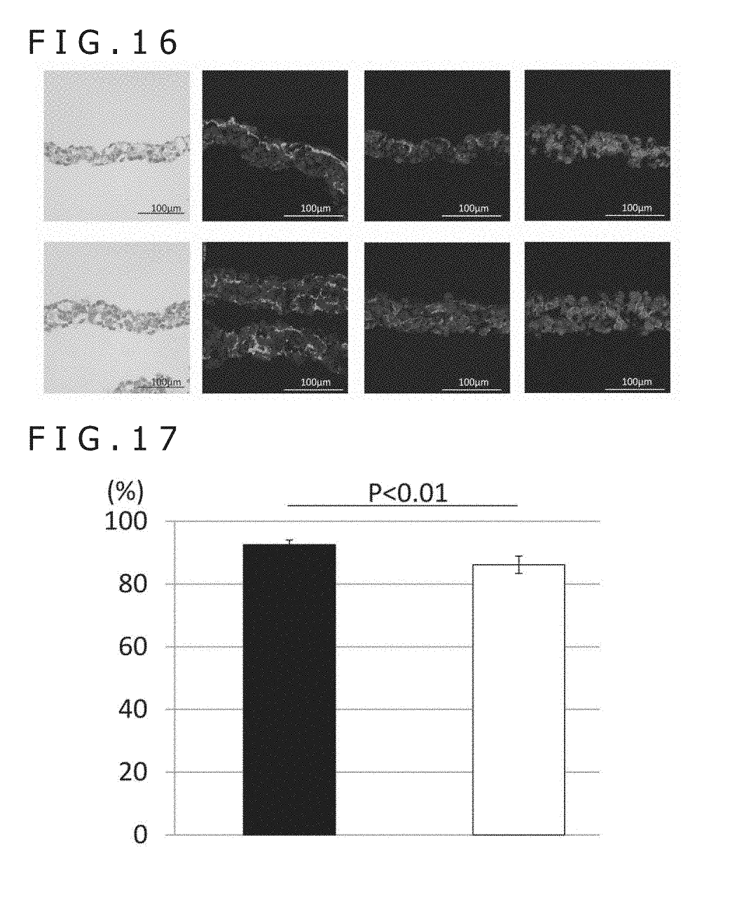

In order to evaluate intercellular adhesion in a sheet-shaped cell culture before freezing and that after thawing, a sheet-shaped cell culture before freezing and a sheet-shaped cell culture thawed after cryopreserved for two days were fixed, sliced and HE stained according to ordinary methods and observed under an optical microscope, whereon it was confirmed that a tissue structure was maintained (FIG. 16, the first photographs from the left). Further, when the same sheet-shaped cell cultures were subjected to immunostaining according to an ordinary method in regard of fibronectin, collagen III or N-cadherin serving as an intercellular matrix component, no difference was observed between the state before freezing and the state after thawing (FIG. 16, the second to fourth photographs from the left). Note that antibodies used here are as set forth in the following table.

TABLE 4
Antibodies used for immunostaining of intercellular matrix components

| | | | | Product |
|---|---|---|---|---|
| | Name of antibody | Host | Maker | No. |
| Primary | Anti-fibronectin antibody | mouse | abcam | ab6328 |
| antibody | Anti-collagen III antibody | rabbit | abcam | ab7778 |
| | Anti-N-cadherin antibody | rabbit | abcam | ab12221 |
| Secondary | Alexa Fluor ® 488 labeled | donkey | Life | A21206 |
| antibody | Anti-rabbit IgG antibody | | Technologies | |
| | Alexa Fluor ® 488 labeled | donkey | Life | A21202 |
| | Anti-mouse IgG antibody | | Technologies | |

(2) Cell Survival Rate

Sheet-shaped cell cultures before freezing or upon thawing after cryopreservation for two days were processed into single cells by TrypLE™ Select (made by Life Technologies Corporation), and were stained with trypan blue, after which live cells were counted by an automated cell counter (Countess™ Automated Cell Counter, made by Life Technologies Corporation), to evaluate cell survival rate (n=10). For statistical evaluation, t test was used. The results are represented in FIG. 17. While the survival rate before freezing was 92.6%±1.5%, the survival rate after thawing was maintained at approximately 86.2%±2.8%, and a lowering in survival rate according to the preservation time was not observed.

(3) Apoptosis

In order to evaluate apoptosis in a sheet-shaped cell culture before freezing and that after thawing, a sheet-shaped cell culture before freezing and a sheet-shaped cell culture thawed after cryopreserved for two days were served to immunostaining by use of apoptosis-related proteins (caspase 8, caspase 9, cytochrome-C and BCL-2) and ss-DNA and to TUNEL staining according to ordinary methods. For the immunostaining, the primary antibodies and secondary antibodies set forth in the following table were individually used. In addition, for TUNEL staining, there was used Click-iT (registered trademark) TUNEL Alexa Fluor (registered trademark) 647 Imaging Assay, for microscopy & HCS (catalog No.: C10247, made by Life Technologies Corporation).

TABLE 5
Antibodies used for immunostaining [0111]

| | | | | Product |
|---|---|---|---|---|
| | Name of antibody | Host | Maker | No. |
| Primary | Anti-caspase 8 antibody | Rabbit | Novus | NB600- |
| antibody | | | Biologicals | 576 |
| | Anti-caspase 9 antibody | Rabbit | abcam | ab2324 |
| | Anti-cytochrome-C antibody | Mouse | abcam | ab13575 |
| | Anti-BCL-2 antibody | Mouse | Dako | M0887 |
| | Anti-ssDNA antibody | Mouse | abcam | ab79439 |
| Secondary | Alexa Fluor ® 488 labeled | Donkey | Life | A21206 |
| antibody | Anti-rabbit IgG antibody | | Technologies | |
| | Alexa Fluor ® 488 labeled | Donkey | Life | A21202 |
| | Anti-mouse IgG antibody | | Technologies | |

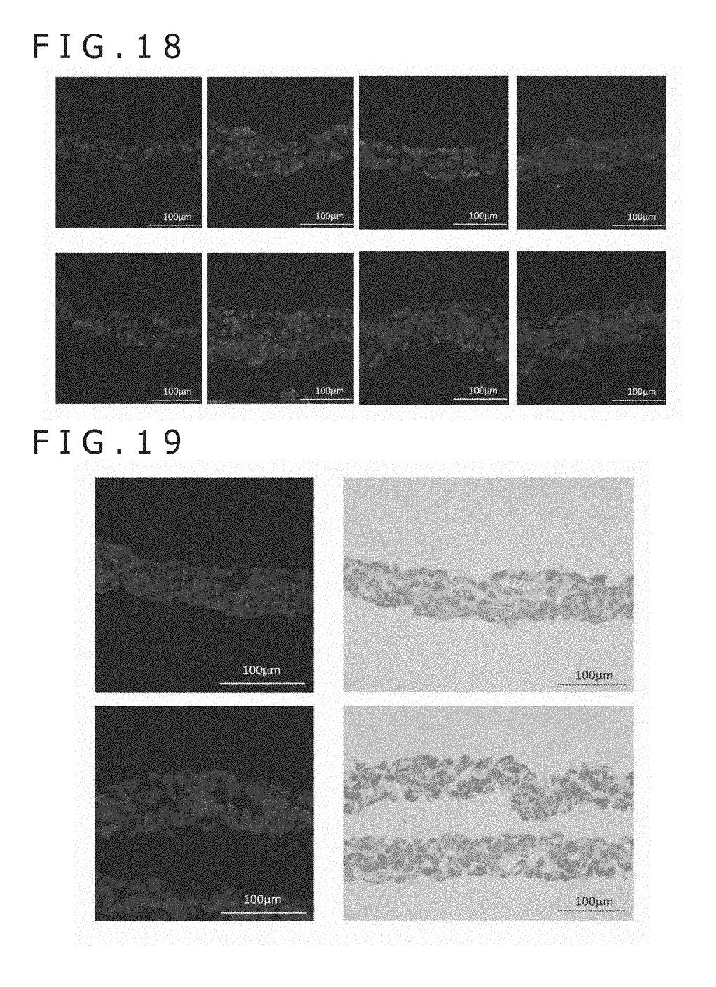

As represented by the results of FIGS. 18 and 19, no large difference in expression of these proteins was observed between before and after the cryopreservation.

(4) Mitochondria Activity

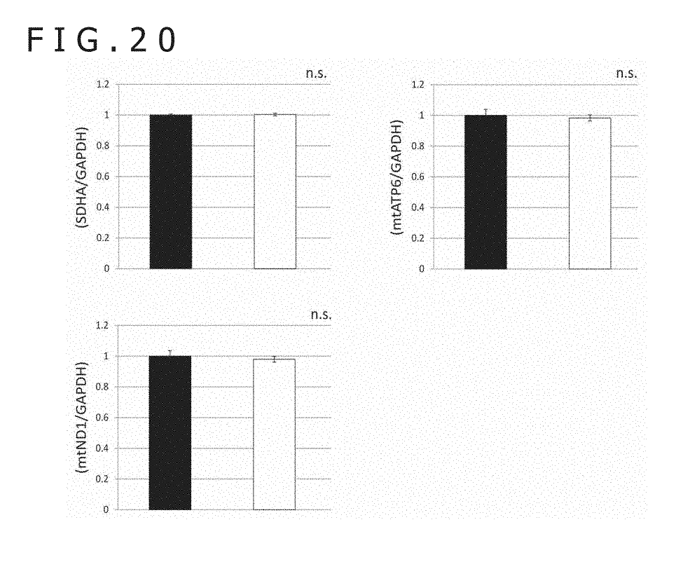

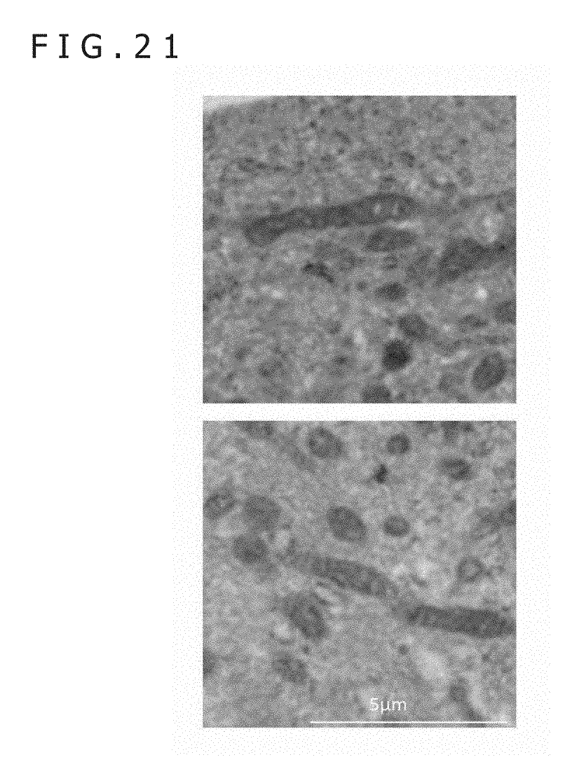

In order to evaluate mitochondria activity in a sheet-shaped cell culture before freezing and that after thawing, gene expression of mitochondria-related proteins (SDHA, mtATP6 and mtND1) in sheet-shaped cell cultures before freezing or upon thawing after cryopreservation for two days was evaluated by real-time PCR by TaqMan® Gene Expression Assay (catalog No.: 4331182, made by Life Technologies Corporation) (Assay IDs of SDHA, mtATP6 and mtND1 are Hs00188166_m1, Hs02596862_g1 and Hs02596873_s1, respectively). Note that GAPDH (Assay ID: Hs03929097_g1) was used as an internal standard, and t test was used for statistical evaluation. As represented by the results of FIG. 20, no difference in mitochondria activity was observed between the state before freezing and the state after thawing. In addition, when the sheet-shaped cell culture before freezing and the sheet-shaped cell culture thawed after cryopreserved were observed under an electron microscope according to an ordinary method, no large change in mitochondria was observed (FIG. 21).

(5) Cytokine Expression

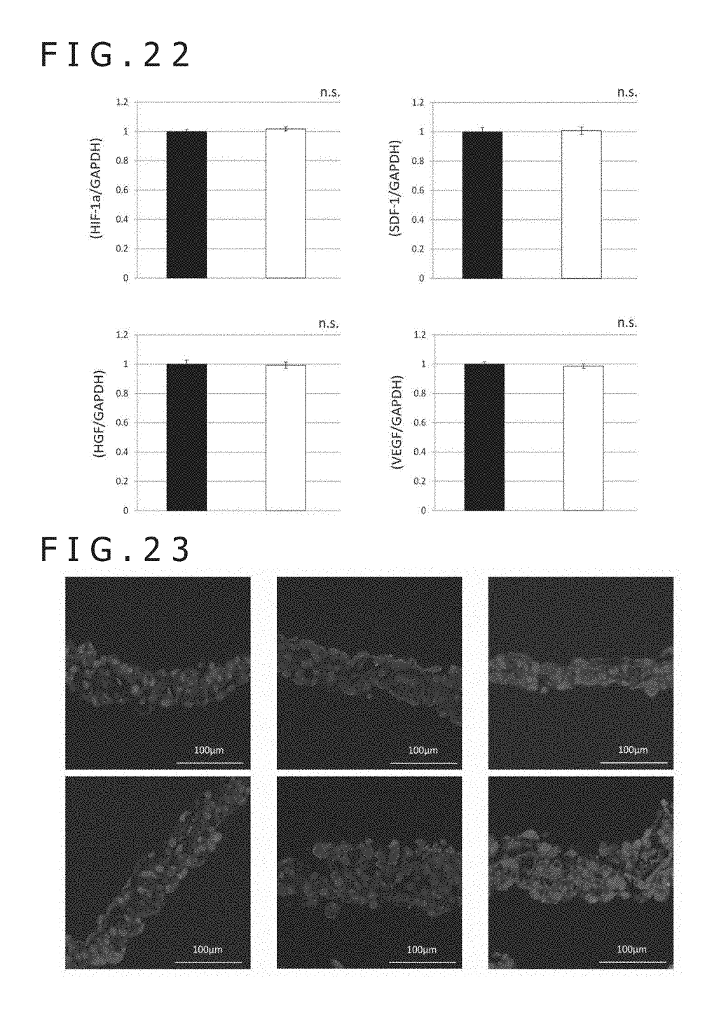

In order to evaluate expression of cytokines in a sheet-shaped cell culture before freezing and that after thawing, gene expression of cytokines (HIF-1α, SDF-1, HGF and VEGF) in sheet-shaped cell cultures before freezing or upon thawing after cryopreservation for two days was evaluated by real-time PCR by TaqMan (registered trademark) Gene Expression Assay (catalog No.: 4331182, made by Life Technologies Corporation) (Assay IDs of HIF-1α, SDF-1, HGF and VEGF are Hs00153153_m1, Hs03676656_mH, Hs00300159_m1 and Hs00900055_m1, respectively). Note that GAPDH (Assay ID: Hs03929097_g1) was used as an internal standard, and t test was used for statistical evaluation. As represented by the results of FIG. 22, no difference in cytokine expression was observed between the state before freezing and the state after thawing. In addition, when the sheet-shaped cell culture before freezing and the sheet-shaped cell culture thawed after cryopreserved were subjected to immunostaining in regard of VEGF, HIF-1α and HGF according to an ordinary method, no difference was observed between the state before freezing and the state after thawing (FIG. 23). Note that the antibodies used are as set forth in the following table.

TABLE 6
Antibodies used for immunostaining of cytokines

| | | | | Product |
|---|---|---|---|---|
| | Name of antibody | Host | Maker | No. |
| Primary | Anti-VEGF antibody | rabbit | abcam | ab46154 |
| antibody | Anti-HIF-1α antibody | mouse | abcam | ab8366 |
| | Anti-HGF antibody | rabbit | abcam | ab83760 |
| Secondary | Alexa Fluor ® 488 labeled | donkey | Life | A21206 |
| antibody | Anti-rabbit IgG antibody | | Technologies | |
| | Alexa Fluor ® 488 labeled | donkey | Life | A21202 |
| | Anti-mouse IgG antibody | | Technologies | |

(6) Proliferative Cells

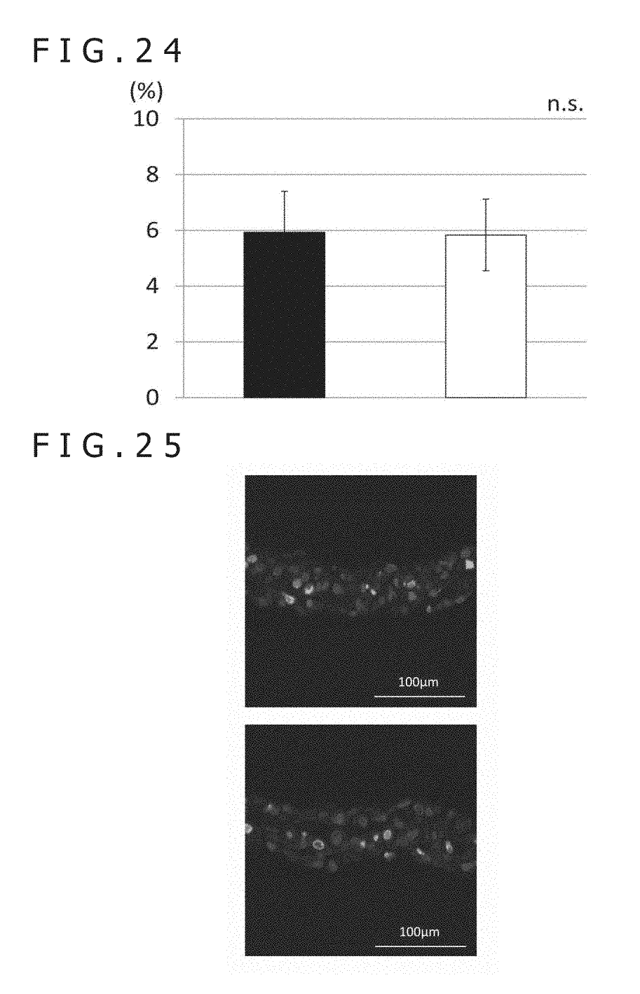

In order to evaluate the proportion of proliferative cells (Ki67 positive cells) contained in a sheet-shaped cell culture before freezing and that after thawing, a sheet-shaped cell culture before freezing and a sheet-shaped cell culture thawed after cryopreserved for two days were served to immunostaining with cell proliferation-related protein (Ki67) according to an ordinary method. For the immunostaining, the primary antibody and secondary antibody as set forth in Table 7 were individually used. The sheet-shaped cell culture before immunostaining freezing and that after thawing were processed into single cells by TrypLE™ Select (made by Life Technologies Corporation), and Ki67 positive rate was counted by an automated cell counter (Countess™ Automated Cell Counter, made by Life Technologies Corporation) (n=5). For statistical evaluation, t test was used. As represented by the results of FIGS. 24 and 25, while the Ki67 positive rate before freezing was 5.9%±1.5%, the Ki67 positive rate after thawing was 5.8%±1.3%, and no difference in Ki67 positive rate was observed between the state before freezing and the state after thawing.

TABLE 7
Antibodies used for immunostaining

| | | | | Product |
|---|---|---|---|---|
| | Name of antibody | Host | Maker | No. |
| Primary | Anti-Ki67 antibody | rabbit | abcam | ab16667 |
| antibody | | | | |
| Secondary | Alexa Fluor ® 488 labeled | donkey | Life | A21206 |
| antibody | Anti-rabbit IgG antibody | | Technologies | |

(7) Microstructure

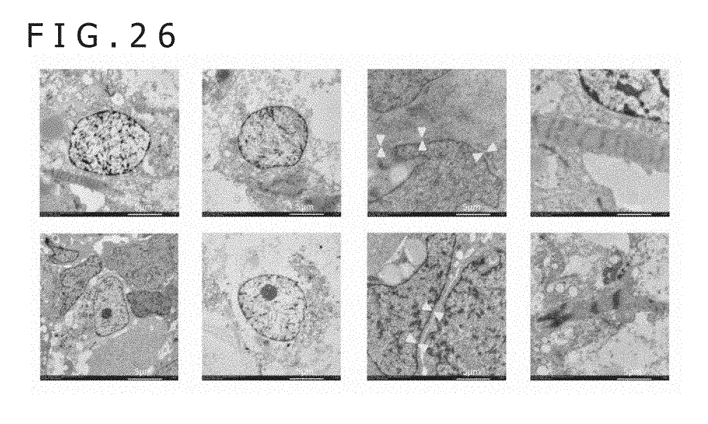

In order to evaluate a microstructure in a sheet-shaped cell culture before freezing and that after thawing, a sheet-shaped cell culture before freezing and a sheet-shaped cell culture thawed after cryopreserved for two days were observed under an electron microscope according to an ordinary method. In regard of cell image, nucleus, intercellular adhesion and sarcomere, no differences were observed between the state before freezing and the state after thawing (FIG. 26), and desmosome indicating that the intercellular adhesion was maintained was confirmed also in the sample after thawing (FIG. 26, the third photographs from the left).

The above results represent that fragile sheet-shaped cell cultures composed of myocardial cells derived from human iPS cells or the like can also be cryopreserved for a long period without deterioration of quality, according to the method of the present disclosure.

Various characteristics of the present disclosure described herein can be combined in various ways, and embodiments obtained by such combinations, inclusive of combinations not specifically described herein, are all within the scope of the present disclosure. In addition, persons skilled in the art understand that a multiplicity of various modifications are possible without departing from the spirit of the present disclosure, and equivalents including such modifications are also included within the scope of the present disclosure. Therefore, it should be understood that the embodiments described herein are mere exemplifications and are not described with an intention to limit the scope of the present disclosure.

The detailed description above describes a freezing method, a cryopreserving method and a transferring method for a sheet-shaped cell culture. The invention is not limited, however, to the precise embodiments and variations described. Various changes, modifications, and equivalents can be effected by one skilled in the art without departing from the spirit and scope of the invention as defined in the accompanying claims. It is expressly intended that all such changes, modifications, and equivalents which fall within the scope of the claims are embraced by the claims.

What is claimed is:

1. A method of freezing a sheet-shaped cell culture, comprising:
(1) a step of immersing in a cryopreservation solution a sheet-shaped cell culture supported by a mesh-shaped support body;
(2) a step of removing the cryopreservation solution adhered to the sheet-shaped cell culture, while keeping the sheet-shaped cell culture supported by the mesh-shaped support body;
(3) a step of enclosing the sheet-shaped cell culture in a cold-resistant film, an upper surface and a lower surface of the sheet-shaped cell culture being covered by the mesh-shaped support body; and
(4) a step of freezing the sheet-shaped cell culture.

2. The method according to claim 1, wherein in the step (1), the sheet-shaped cell culture is immersed in the cryopreservation solution for 1 to 30 minutes.

3. The method according to claim 1, wherein in the step (2), the cryopreservation solution adhered to the sheet-shaped cell culture is removed by dropping through the mesh-shaped support body.

4. The method according to claim 1, wherein in the step (3), the sheet-shaped cell culture is enclosed in the cold-resistant film in such a manner that a hermetically sealed state can be maintained.

5. The method according to claim 1, wherein in the step (4), the sheet-shaped cell culture is frozen by being disposed over a liquid surface of liquid nitrogen.

6. The method according to claim 1, wherein the step (4) is conducted after the step (3).

7. A method of cryopreserving a sheet-shaped cell culture, comprising:
(1) a step of immersing in a cryopreserving solution a sheet-shaped cell culture supported by a mesh-shaped support body;
(2) a step of removing the cryopreservation solution adhered to the sheet-shaped cell culture, while keeping the sheet-shaped cell culture supported by the mesh-shaped support body;
(3) a step of enclosing the sheet-shaped cell culture in a cold-resistant film, an upper surface and a lower surface of the sheet-shaped cell culture being covered by the mesh-shaped support body;
(4) a step of freezing the sheet-shaped cell culture; and
(5) a step of preserving the frozen sheet-shaped cell culture at a low temperature while keeping the sheet-shaped cell culture enclosed in the film.

8. The method according to claim 7, wherein in the step (1), the sheet-shaped cell culture is immersed in the cryopreservation solution for 1 to 30 minutes.

9. The method according to claim 7, wherein in the step (2), the cryopreservation solution adhered to the sheet-shaped cell culture is removed by dropping through the mesh-shaped support body.

10. The method according to claim 7, wherein in the step (3), the sheet-shaped cell culture is enclosed in the cold-resistant film in such a manner that a hermetically sealed state can be maintained.

11. The method according to claim 7, wherein in the step (4), the sheet-shaped cell culture is frozen by being disposed over a liquid surface of liquid nitrogen.

12. The method according to claim 7, wherein the step (4) is conducted after the step (3).

13. A method of transferring a sheet-shaped cell culture, comprising:
(1) a step of immersing in a cryopreservation solution a sheet-shaped cell culture supported by a mesh-shaped support body;
(2) a step of removing the cryopreservation solution adhered to the sheet-shaped cell culture, while keeping the sheet-shaped cell culture supported by the mesh-shaped support body;
(3) a step of enclosing the sheet-shaped cell culture in a cold-resistant film, an upper surface and a lower surface of the sheet-shaped cell culture being covered by the mesh-shaped support body;
(4) a step of freezing the sheet-shaped cell culture; and
(5) a step of transferring the frozen sheet-shaped cell culture while keeping the sheet-shaped cell culture enclosed in the film.

14. The method according to claim 13, wherein in the step (1), the sheet-shaped cell culture is immersed in the cryopreservation solution for 1 to 30 minutes.

15. The method according to claim 13, wherein in the step (2), the cryopreservation solution adhered to the sheet-shaped cell culture is removed by dropping through the mesh-shaped support body.

16. The method according to claim 13, wherein in the step (3), the sheet-shaped cell culture is enclosed in the cold-resistant film in such a manner that a hermetically sealed state can be maintained.

17. The method according to claim 13, wherein in the step (4), the sheet-shaped cell culture is frozen by being disposed over a liquid surface of liquid nitrogen.

18. The method according to claim 13, wherein the step (4) is conducted after the step (3).
